(19) United States
(12) Patent Application Publication
(10) Pub. No.: US 2025/0073806 A1
(43) Pub. Date: Mar. 6, 2025

(54) BAND FLASH BUTT WELDING MACHINE AND GROUP OF ACCESSORIES FOR A BAND FLASH BUTT WELDING MACHINE

(71) Applicant: WIKUS-Sägenfabrik Wilhelm H. Kullmann GmbH & Co. KG, Spangenberg (DE)

(72) Inventors: Jörg H. Kullmann, Spangenberg (DE); Matthias Kraft, Spangenberg-Elbersdorf (DE)

(73) Assignee: WIKUS-Sägenfabrik Wilhelm H. Kullmann GmbH & Co. KG, Spangenberg (DE)

(21) Appl. No.: 18/952,785

(22) Filed: Nov. 19, 2024

Related U.S. Application Data
(63) Continuation-in-part of application No. PCT/EP2023/062928, filed on May 15, 2023.

(30) Foreign Application Priority Data
May 20, 2022 (DE) 10 2022 112 795.8
May 20, 2022 (DE) 10 2022 112 796.6

(51) Int. Cl. B23K 11/04; B23K 11/00; B23K 11/30; B23K 37/04

(52) U.S. Cl. CPC B23K 11/046; B23K 11/0026; B23K 11/30; B23K 37/0435; B23K 37/0452

(57) ABSTRACT

Various embodiments relate to a band flash butt welding machine by which it is possible to weld band faces of band ends of at least one band, in particular a saw band, to each other. The band flash butt welding machine comprises clamping elements for clamping the band ends. Furthermore, the band flash butt welding machine comprises aligning elements for aligning the band ends. The second clamping elements can be moved by a drive relative to the first clamping elements in the direction of a longitudinal axis. Two aligning elements are fixedly connected to one another by a coupling device, in particular a bridge part. The coupling device defines the relative alignment of the aligning elements. The second clamping element can be moved relative to the two aligning elements. This design is advantageous for a changeover of the band flash butt welding machine for band ends having a different geometry.

### CROSS REFERENCE TO RELATED APPLICATIONS

This application is a continuation-in-part of International Application No. PCT/EP2023/062928 with an international filing date of May 15, 2023 and claiming priority to co-pending German Patent Application No. DE 10 2022 112 795.8 entitled “Band-Abbrennstumpfschweifßmaschine, Anbaugruppe für eine Band-Abbrennstumpfschweifßmaschine und Anordnung”, filed on May 20, 2022 and co-pending German Patent Application No. DE 10 2022 112 796.6 entitled “Band-Abbrennstumpfschweifßmaschine”, filed on May 20, 2022, the disclosures of which are hereby incorporated herein by reference in their entirety.

### FIELD OF THE INVENTION

The invention relates to a band flash butt welding machine. With such a band flash butt welding machine, any ends of bands or strips (in the following “bands”) (in particular of metallic bands with a constant cross-section in the direction of the longitudinal axis) can be welded flush with one another in the region of the end faces. In particular, the end faces of band ends
of two bands which are arranged coaxially and flush with their end faces can be welded with one another to form a band string whose length corresponds to the cumulated length of the two bands, or
of a single band which is bent into a band ring with a gap in the area of the end faces can be welded with one another, which provides an “endless” band strand after welding.

The flash butt welding process is a press-welding process in which
the required welding heat is generated by creating an electric arc between the components to be welded (in this case: the end faces of the band ends) by means of an electrical bias of band flash butt welding machine electrodes which contact the components to be welded (in this case: the band ends), and
the components heated in this way (here the band ends with their end faces) are pressed together with a pressing force, which results in the components being welded together via a weld seam.

In the following, in some cases reference is made to the design of the band as a saw band, in which case the end faces of the saw band ends of an annularly bent saw band can be welded in order to produce an “endless” saw band strand. These references then also apply accordingly to at least one band that is not embodied as a saw band.

A manufacturing process carried out with a cutting tool is referred to as “chip machining” in accordance with German Industrial Standard DIN 8589-0. According to this standard, a distinction is made between chip machining with geometrically defined cutting edges and chip machining with geometrically undefined cutting edges. Cutting with geometrically defined cutting edges also includes sawing in accordance with DIN 8589-6. According to this standard, sawing does not include chip machining with geometrically undefined cutting edges. In practice, however, chip machining bands coated with cutting particles are still referred to as saw bands. Therefore, when the present patent application/the patent refers to a saw band, this includes both a saw band with teeth with geometrically defined cutting edges as well as a saw band with geometrically undefined cutting edges.

### BACKGROUND OF THE INVENTION

The website
www.youtube.com/watch?v=_BqfobJ-tY0
(Date of access to the website: 14.01.2022)
   shows the welding of band ends to form a closed band strand using an “IDEAL BAS 340” flash butt welding machine from IDEAL-Werk C.+E. Jungeblodt GmbH+Co KG, Lippstadt. To insert the band into the band flash butt welding machine, it is bent into a ring that is closed except for a gap between the end faces of the band ends. The ends of the band facing each other are then inserted from both sides into the band flash butt welding machine and optionally placed with their end faces against an insertion stop. The band flash butt welding machine has an alignment and clamping unit on both sides of the insertion stop. One alignment and clamping unit is firmly connected to the foundation (in particular a substructure or supporting structure) of the band flash butt welding machine. The other alignment and clamping unit is guided for a translator motion in the direction of the longitudinal axis of the band relative to the foundation in the manner of a slide and can be moved by means of a drive. Each alignment and clamping unit has a stop rail with a vertical stop surface. A band back of the associated band end is placed against the stop rail. The stop rails carry horizontally oriented support pins on which the band ends can be put. Once the operator has brought the band ends into the predetermined positions and orientations which are defined by the stop surface, the support bolts and the insertion stop of the alignment and clamping units, the band ends are each clamped and fixed by means of clamping elements of the associated alignment and clamping unit, which are actuated via actuators. If an insertion stop was used, the insertion stop is subsequently moved out of the gap between the end faces of the band ends. The width of the gap between the end faces of the band ends is automatically reduced to the gap size required for the electric arc during the flash butt welding process. For this purpose, the drive moves the movable alignment and clamping unit along the translational degree of freedom relative to the foundation and relative to the fixed alignment and clamping unit until the end faces of the band ends establish the gap required for the electric arc. The clamping elements form the band flash butt welding machine electrodes. As a result of the contact of the clamping elements with the band ends, an electrical bias of the band flash butt welding machine electrodes leads to the formation of the electric arc between the end faces of the band ends. Already during the generation of the electric arc, the band ends are moved towards each other by a relative movement of the alignment and clamping units, the time course of the relative movement being defined by a rotating cam disk. At the end of the movement of the cam disk, the electric arc is switched off in a time-controlled manner. The ends of the band are then upset until the joint has cooled by an upsetting pressure cylinder applying an upsetting force to the movable alignment and clamping unit. The weld seam and the adjacent material areas of the band ends are then annealed and the weld seam is deburred. During the processing operations, the relative degree of freedom between the two alignment and clamping units can also be used to change the locations at which the band strand is clamped by the clamping elements and/or to cause a displacement of the band strand in the direction of its longitudinal axis and/or to provide compression or tensile tension in the band strand. If, for example, a tool for deburring the weld seam is arranged at an offset to the weld seam produced, the clamping elements of the fixed alignment and clamping unit can be released and the movable alignment and clamping unit is moved along the degree of freedom according to the offset by means of the drive. If the clamping elements of the movable alignment and clamping unit are closed during this movement, the band ends and the weld seam are also moved by the offset from the working area in which the weld seam was created to the working area of the tool for deburring. This movement increases the distance between the clamping elements of the fixed alignment and clamping unit and the weld seam. The clamping elements of the fixed alignment and clamping unit are then closed again. Now the clamping elements of the movable alignment and clamping unit are opened and the drive moves these clamping elements until the clamping elements have the same distance from the weld seam as the clamping elements of the fixed alignment and clamping unit. The clamping elements of the movable alignment and clamping unit are then closed again. The weld seam can then be deburred. The resulting distances between the pairs of clamping elements from the weld seam and thus from each other can be dimensioned such that the deburring tool (in this case a planer) can be moved between the clamping elements along the weld seam. On the other hand, the distance between the clamping elements on both sides of the weld seam can also be changed in a corresponding manner in order to enable the clamping of the band ends at different distances from the end faces for the individual processing steps. For example, a smaller distance may be required for the flash butt welding than for the deburring and/or annealing. It is also possible that, using the relative degree of freedom between the two alignment and clamping units during processing, the band ends with the weld seam are compressed or upset by the drive. This is achieved by the drive biasing i the movable alignment and clamping unit in the direction of the fixed alignment and clamping unit n a force-controlled way when the clamping elements are in the closed state.

A corresponding flash butt welding machine is also described in EP 2 540 431 B1.

Other flash butt welding machines are offered by the company TEMELSAN MAKINA (cp. www.youtube.com/watch?v=vTq9BCQz1 Mc; www.temelsan.de).

U.S. Pat. No. 2,203,151 A corresponding to U.S. Pat. No. 2,253,709 A discloses a flash butt welding machine with which ends of metal sheets provided by smaller coils are welded together to produce a longer overall sheet, which is then wound onto a larger coil and which can then be fed continuously from the larger coil to a cold forming process or a descaling process. In the flash butt welding machine, the ends to be joined together are first cut in a cutting unit. In a welding unit, the two ends are clamped by clamping elements and brought into a predetermined alignment with each other, in which the weld seam connecting the ends is then produced. The welded metal sheets are then transported from the welding unit to a trimming unit located downstream, wherein excess welding material is removed from the weld seam. To ensure the desired alignment of the metal sheets in the area of the welding unit, the edges of the metal sheets are laterally guided by disks. The lateral position of the disks can be adjusted by motor or manually using screws. The clamping elements for the metal sheets have a vertical degree of freedom, which allows the clamping elements to be opened and closed and an adaptation to different sheet thicknesses.

DE 41 07 984 A1 corresponding to GB 2 254 815 B discloses a flash butt welding machine, in which a band flash butt welding machine electrode is attached to an electrode holder via a screw connection. The electrode holder is in turn held on an electrode stand. For this purpose, the electrode holder has a lateral T-groove. The electrode holder comprises a T-shaped groove block. If the groove block of the electrode stand is arranged in the T-groove of the electrode holder, the groove block can be tightened by a hydraulically actuated piston of the electrode stand, whereby the electrode holder can be pulled against a lateral clamping surface of the electrode stand. The band flash butt welding machine electrode has a fitting surface on the underside, which is clamped against an upper contact surface of the electrode holder using the screw connection. The fitting surface is used to ensure the desired distance between the band flash butt welding machine electrode and the welding point. In order to enable the band flash butt welding machine electrode to be used again after reworking the band flash butt welding machine electrode in the event of wear without changing the height of the upper contact surface of the band flash butt welding machine electrode, several electrode holders can be used in which the upper contact surface for the fitting surface of the band flash butt welding machine electrode is arranged at different heights. The differences in heights of the electrode holders compensate for the reduction in the height of the band flash butt welding machine electrode as a result of wear and reworking.

U.S. Pat. No. 3,469,064 A discloses a flash butt welding machine comprising a pair of upper clamping jaws and a pair of lower clamping jaws. The distance between the pairs of clamping jaws can be changed so that a left band can be clamped between the left clamping jaws and a right band can be clamped between the right clamping jaws. The right and left clamping jaws can then be moved laterally so that the end faces of the two bands are pressed against each other. An electrical circuit running across the clamping jaws is closed via the contact between the end faces of the bands. The clamping jaws are held on holders, which in turn are held on retaining plates via a wedge connection and an actuator. Spacer plates allow the distance between the clamping jaws to be adjusted for different geometries of the bands of the flash butt welding machine.

WO 2022/030411 A1 relates to a saw band comprising sections with band backs being inclined upwards and downwards. The inclinations of the band backs are intended to cause a pressure roller rolling along the band back to bring about an oscillating vertical movement of the saw band, which is intended to support the sawing process. To produce such an endless loop-shaped saw band, the saw band is cut to the required length and the two end faces are pressed against each other and welded to each other. One problem mentioned here is that the end faces of the saw band to be welded together may comprise different heights depending on the length of the cut-to-length saw band due to the different inclinations of the band backs of the partial sections, so that after the welding the band back comprises a step. To avoid such steps, WO 2022/030411 A1 proposes that a saw band semi-finished product, from which the saw bands are cut to a length, comprises periodic longitudinal sections which begin and end with a flattening of the band back. The sections with the inclined band backs are then arranged between these flattenings. Cutting to length then takes place in the area of the flattened sections, thus avoiding that the end faces to be welded together have different heights. The flattened sections of the band back are also used in the welding machine to support the band back on aligning elements arranged on both sides of the contacting end faces. In order to be able to recognize the sections of the saw band with the flattenings and thus the area for cutting to length and for welding, the surface of the saw band can be provided with markings in the area of the flattenings. In addition to the aforementioned aligning elements contacted by the flattenings of the saw band at a distance from the contacting end faces, there is a central aligning element which is contacted by the band back in the area of the contacting end faces. After alignment, the band ends of the saw band with their end faces in contact with each other are each clamped by electrodes. After the band ends have been clamped by the electrodes in the alignment defined by the aligning elements, the central aligning element is removed from the band back. The end sections are pressed against each other by a relative movement of the electrodes and the electrical energization of the electrodes leads to flash butt welding of the end faces. It is also proposed that the saw band can be aligned with the teeth on the aligning elements. The user operates the welding machine and, in particular, recognizes the marked section of the saw band for welding the end faces. The two pairs of an aligning element and the associated electrode are each fixed to a machine table part. The machine table parts (with the associated pairs of an aligning element and the electrode) are the moved relative to each for pressing the band faces against each other during the flash butt welding process.

U.S. Pat. No. 5,931,369 A proposes a welding machine for endless saw bands welded together to form a loop. The publication is devoted to ensuring the desired alignment of the band ends prior to the welding process in order to ensure that a flush weld seam is produced in the area of the band back, of the teeth and of the side surface without a step or angle between the band ends. According to U.S. Pat. No. 5,931,369 A, the band ends of a saw band are to be welded with the band back comprising a slightly smaller length than the band front of the saw band comprising the teeth. In this way, the saw band comprises a curvature in such a way that improved guidance of the saw band in the sawing machine is achieved. Since in this case the band ends also comprise a natural curvature, special measures are required for the exact alignment of the band ends for the welding process. U.S. Pat. No. 5,931,369 A proposes that three linear sensors are provided on a table of the welding machine on both sides of the welding head at equal distances. Each of the sensors detects the transverse positions of the band back at different points of an assigned band end. The measurement signals from the sensors are fed to a microprocessor, which displays the measurement signals on a display. Based on the measurement signals, the microprocessor calculates the curvature for each band end, an angular deviation of the band back of the band end from a reference line in the area of the contacting end faces and a lateral offset of the band back from the reference line in the area of the contacting end faces. The microprocessor then uses these values to calculate an angular deviation of the band ends and a lateral offset of the band ends. After this measurement and evaluation, the holders for the band ends are released. A user can then manually change the alignment of the band ends until the band ends are exactly aligned with each other or the angular deviation and lateral offset of the band ends calculated on the basis of the sensors is within a predetermined tolerance range. During this manual fine adjustment, the user can monitor the respective position and alignment by observing the displayed angular deviation and transverse offset of the band ends. Alternatively, it is suggested that the holders are held movably on the table of the welding machine so that the band ends do not need to be released from the holders, but can be aligned by the movement of the holders. In this case, the movement of the holders can be brought about manually by the user by operating two pairs of rotary wheels, each of which being to a pair of holders for an associated band end. Alternatively, the adjustment of the holders can be carried out by an automatic mechanism.

DE 921 763 B discloses a welding machine by which a plurality of hot-rolled bands wound to a coil are joined in order to enable continuous passage of the band strand produced through a pickling line. DE 921 763 B describes, on the one hand, that it is known to align the band ends by using a fixed stop of the welding machine. However, according to the publication a precise alignment of the band ends cannot be guaranteed in this way and the fixed stop can lead to a damage to the band edges as a result of excessive contact pressure. DE 921 763 B also describes that it is known that the fixed clamping side can comprise a slide. The slide can then be used for a transverse adjustment in order to align the band ends. This way of adjustment is described to be time-consuming. Furthermore, this known embodiment criticized in that it does not guarantee exact alignment of the band ends, but at the best alignment of the central longitudinal axes of the band ends, which leads to a step in the band edges in the joining area if there are tolerances in the width of the bands. Against this background, DE 921 763 B proposes that the alignment is provided by means of a four-point-contact-system with a continuously variable pressure adjustment. The four-point-contact-system comprises two lateral centering devices. The lateral centering devices each clamp the bands on both sides. The lateral centering devices are actuated by hydraulic cylinders that are pressurized with the same pressures via a common hydraulic circuit. The piston of the hydraulic cylinder is coupled via articulated levers to the end-sided sliding groove blocks of two slides, which are arranged on both sides of the band ends. Adjustable sliders are held on the slides via spindles. On the sliders sliding shoes are in turn held. The distance between the sliding shoes is adjusted to a specific width of the band ends by manually actuating the spindle drives. Depending on the hydraulic bias of the cylinders, the lateral centering devices assume a released position, in which the distance between the sliding shoes is greater than the width of the band ends, or a clamping position, in which the sides of the band ends are laterally clamped between the sliding shoes. If the sliding shoes clamp the band ends, the central longitudinal axes of the band ends are aligned with each other and extend centrally in the welding machine. After the automatic lateral center adjustments of the band ends, the band ends are vertically clamped by vertical clamping devices in the welding machine, a sword is pulled out between the end faces of the band ends, the lateral centering devices are transferred into the released position and the band ends are welded together. The spindle drives can also be used to compensate for different band widths by an off-center adjustment. This can be done by moving the spindle drives of the slides arranged on both sides of the band to different operating positions.

Further prior art is known from the publications U.S. Pat. No. 2,203,151 A corresponding to U.S. Pat. No. 2,203,151 A, KR 10 2011 0 018 734 A, JP S55-81 088 A, CN 110 948 095 A, CN 102 371 400 A and CN102319950A.

### SUMMARY OF THE INVENTION

A band flash butt welding machine is proposed which is improved in particular with regard to
ensuring the required alignment of the band ends in the band flash butt welding machine and
the effort for a changeover of the band flash butt welding machine for a change from the use of the same for processing a first type of band to a second type of band having a different geometry.

One proposed embodiment bases in particular on the realization that in accordance with the state of the art referred to at the beginning as documented by www.youtube.com/watch?v=_BqfobJ-tY0 the quality of the weld seam produced and of the band strand produced depends essentially on the exact positioning and orientation of the band ends (position and/or orientation hereinafter referred to as “alignment”) during processing and thus on the position and/or orientation of the stop rails of the alignment and clamping units. If, after welding at least one band of a first type, the band flash butt welding machine is to be used to weld at least one band of a second type with different dimensions (in particular a different cross-sectional geometry), an adjustment of the two stop rails in the horizontal plane transverse to the longitudinal axis of the band strand is required (hereinafter also referred to as “changeover”). Such a changeover is necessary, for example, for a modified band height of the bands to be welded. Such a changeover may also be necessary, for example, if the saw band height does not change during the welding of saw bands, but the tooth height of the saw band teeth does change. The reason for this is that the weld seam is preferably created in the area of the tooth base of the teeth, which means that a change in tooth height may make it necessary to convert the stop rails despite the band saw blade having the same overall height.

When making the necessary manual adjustments to the stop rails, the operator has to ensure both the correct alignment of the two stop rails relative to each other and the correct alignment of the stop rails in relation to the clamping elements, to the band flash butt welding machine electrodes and to the processing tools of the band flash butt welding machine. This is time-consuming and requires careful and experienced workmanship. Another complicating factor can be that tightening the fixing screws of the stop rails to fix the same after the desired alignment has been achieved can lead to undesirable changes in the alignment of the stop rails. Therefore, the stop rails must be repeatedly adjusted and screwed in an iterative process with repeated intermediate checks and, if necessary, fine adjustments of the alignment.

In practice, for the reasons mentioned above, the alignment process of the stop rails for a changeover of the band flash butt welding machines according to the prior art leads to increased changeover times. If the alignment is not changed with the required precision, there is a risk that the subsequent weld will not meet the requirements. In the following, only some exemplary consequences of a non-precise adjustment of the alignment of the stop rails according to the state of the art are mentioned if the band to be welded is embodied as a saw band:
a) If the band backs of the two saw band ends are welded together with an offset in the main extension plane transverse to the direction of band travel, this leads to undesirable force and displacement jumps for the forward thrust of the saw band in the direction of the saw channel of the processed workpiece during operation of the saw band strand.

In addition, in this case the weld seam does not extend over the entire front surfaces of the saw band ends, which leads to a reduced strength of the saw band strand.
b) If the tooth bases of the two ends of the band saw are not flush or with each other, this can result in poorer sawing behavior, poorer chip transport during sawing and/or reduced durability of the saw band strand.
c) It is also possible that if the tooth bases are not aligned flush during the welding process, a tooth of the saw band may set up in the area surrounding the weld seam. In this case, the subsequent deburring process not only removes excess weld material, but also material from the tooth. The reduced thickness of the tooth can then lead to undesirable scoring in the sawn surface when the band saw blade is used later, for example. On the other hand, this can lead to a reduction in the thickness of the front faces welded to each other. This results in a thinner weld seam, which can lead to premature failure of the weld seam during operation.
d) Impairment of the strength and the sawing pattern can also occur if the cross-section of the weld seam is not rectangular but trapezoidal (when cutting in the direction of band travel and in a vertical plane) due to an error in aligning the ends of the saw band.

Against the background of these disadvantages of known band flash butt welding machines, a band flash butt welding machine is proposed to which, in principle, what has been said for the band flash butt welding machines according to the prior art applies. The band flash butt welding machine comprises first clamping elements, by means of which a first band end can be clamped, and second clamping elements for clamping a second band end. It is possible that at least one clamping element is embodied as a multifunctional band flash butt welding machine electrode. Furthermore, the band flash butt welding machine has a first aligning element for aligning the first band end and a second aligning element for aligning the second band end. In the present context, an “alignment” comprises a setting of an orientation of the band end (in particular in a horizontal plane and/or in a vertical plane) and/or a setting of a position of the band end, in particular in a horizontal plane in a direction transverse to the longitudinal axis of the band and/or in a height direction of the band end. To give just one non-limiting example, the aligning elements can comprise a horizontal aligning surface on which the respective band end rests and/or a vertical aligning surface on which a band back or the teeth of a saw band rest. The aligning elements can generally also be embodied as a stop rail, as is the case in the state of the art.

In one embodiment, the second clamping elements are movable via a drive relative to the first clamping elements with a movement in the direction of a longitudinal axis of at least one band, which is aligned by means of the aligning elements and is clamped by the clamping elements. This movement can be force-controlled or displacement-controlled for the purposes that have been given as examples for the corresponding movement for the prior art embodiments mentioned at the beginning.

The first aligning element and the second aligning element are coupled to each other via a coupling device. The coupling device specifies a relative alignment of the first and second aligning elements.

Whereas according to the prior art, the operator had to set the relative alignment of the first and second stop rails to one another for a changeover of the band flash butt welding machine, here this can be provided by the coupling device. On the one hand, this saves effort during the changeover of the band flash butt welding machine. On the other hand, the setting of the desired relative alignment of the alignment elements no longer depends on the care of the operator, but the coupling device ensures “automatically” that the required relative alignment (within the limits specified by the precision of the coupling device) is guaranteed in every case.

The second clamping elements can be moved translationally in the direction of the longitudinal axis of the at least one band relative to the two aligning elements by means of the drive. During this movement, there is thus a relative sliding movement at least of the band end which is clamped by the second clamping elements, relative to the second sliding element. Such a movement of the second clamping elements can, for example, take place in order to
move the band ends and, if applicable, a weld seam already created between them from one working area to another working area and/or
create the required width of the gap between the end faces to generate the electric arc and/or
upset the band strand and/or
change the clamping distance of the clamping elements clamping the band strand and/or
press the end faces of the band ends together after generating the welding heat with the electric arc.

Here, the drive can generate the movement in a force-controlled or displacement-controlled manner.

However, while in the prior art embodiment the drive comprised a slide that moves both the second clamping elements and the second stop rail, the present embodiment releases the coupling of the second clamping elements with the second aligning element and enables a relative movement between them for the first time. This is what makes the use of the coupling device between the first aligning element and the second aligning element possible.

There are different options for the type of design of the coupling device, which defines the relative alignment of the first and second aligning elements.

In a first variant, the coupling device is an electronic coupling device. It is possible, for example, that for the changeover the first aligning element and the second aligning element are each moved in a direction transverse to the longitudinal axis of the band via an electronically controlled drive (open loop control or closed loop control). In this case, the aligning elements can each be guided relative to each other via a transverse guide device in such a way that the aligning surfaces of the aligning elements are oriented parallel to each other along the transverse guide devices, regardless of the position of the aligning elements. The two drives then only ensure that the two aligning surfaces, stop surfaces or vertical surfaces of the alignment elements are not offset from each other in the transverse direction, but are arranged in one plane. It is possible that the electronic coupling device is a pure open loop control unit that controls with the control aim to achieve the same displacements of the two aligning elements in the transverse direction. However, it is also quite possible that the electronic coupling device comprises a closed loop control system in which the positions of the aligning elements in the transverse direction are each measured by means of a sensor. The drives are then closed loop controlled on the basis of the signals from the sensors so that the desired position in the transverse direction is approached and both aligning elements are displaced by the same distance in the transverse direction so that the aligning surfaces, stop surfaces or vertical surfaces are arranged in one plane. The use of an electronic coupling device is also particularly advantageous in the context of automating the processing of the at least one band by means of the band flash butt welding machine and in the context of a partial or full automatic changeover of the band flash butt welding machine.

For a second variant, the coupling device is a mechanical coupling device. The mechanical coupling device fixedly connects the first aligning element and the second aligning element during the changeover. The mechanical coupling device thus ensures during the changeover that the two alignment elements comprise the correct positions relative to one another and are aligned. In other words, the aligning elements and the mechanical coupling device form a unit in the band flash butt welding machine, in which the aligning elements and the mechanical coupling device are moved together. In this case, it is only necessary to ensure that this unit is moved in a direction transverse to the longitudinal axis of the band by the amount required for the changed type of band (without a transverse guide device for the unit, it must also be ensured that the unit comprises the correct orientation parallel to the longitudinal axis of the band).

There are many options for the design of the mechanical coupling device. For one proposal, the coupling device comprises a bridge part, which in the simplest case can be a bridge plate. The bridge part has different sections, namely a first bridge part section and a second bridge part section. The aligning element can be attached, in particular screwed, to the respective bridge section. In this case, for example during initial assembly or at regular intervals or for readjustment, the alignment elements can be screwed to the associated bridge section in the correct alignment with the said unit. This screw connection and alignment then no longer needs to be changed during the changeover. However, it is also possible that the bridge part section directly forms the first aligning element. The bridge part also comprises a recess, which is arranged between the first bridge part section and the second bridge part section. In the area of the recess (when projected into a common same horizontal plane), the weld seam can then be created, a tool of the band flash butt welding machine can be arranged or moved and/or the first clamping elements and the second clamping elements and/or the band flash butt welding machine electrodes can be arranged. Here, the recess has a sufficient dimension in the horizontal plane to allow relative movement between the bridge part and the clamping elements and band flash butt welding machine electrodes during changeover.

For one proposal, the bridge part is U-shaped in a rough approximation. In this case, an aligning element is arranged in each case in the region of a vertical leg of the U (preferably with the vertical aligning surface aligned parallel to the base leg of the U) and the recess is limited by the horizontal leg and the vertical legs of the U, the recess being open in the direction away from the horizontal leg. In this case, the horizontal leg of the U of the bridge part provides the connection of the two aligning elements and the associated bridge part sections.

In principle, it is possible that the mechanical coupling device exclusively defines the position of the two aligning elements relative to one another, while the position of the coupling device with the aligning elements in the transverse direction and/or the correct orientation of the same relative to the band flash butt welding machine in the horizontal plane must then still be set by the operator during the changeover, for example by screwing the coupling device to the foundation of the band flash butt welding machine in the correct position and/or orientation. A further increase in precision and/or a reduction in the effort required for the changeover can be achieved for one proposal according to which the band flash butt welding machine comprises a transverse guiding device. The transverse guiding device guides the mechanical coupling device with the aligning elements held on it in such a way that the coupling device with the aligning elements held on it (apart from any small remaining tolerances of the transverse guiding device) comprises only a single degree of freedom in the transverse direction. This degree of freedom can then be used for the necessary adjustment during the changeover, while the cross-guiding device ensures that the aligning elements comprise the desired orientation relative to the band flash butt welding machine. For this proposal, the changeover of the band flash butt welding machine therefore only requires an adjustment in the transverse direction.

All transverse guiding devices known from the state of the art can be used here. It is possible that two transverse guide devices with parallel transverse guide axes, which are spaced apart from one another, are used. Preferably, only one single transverse guiding device is used, which can be arranged, for example, in a side area of the band flash butt welding machine. The transverse guide device is here embodied as a linear guide of one of the known embodiments. The linear guide can be based on a sliding bearing or a roller bearing. To cite merely one example, the transverse guide device can be a linear guide in the form of a prismatic or trapezoidal guide, in which the cross-sections of the parts moving relative to one another form a positive fit, so that these linear guides merely comprise one single remaining degree of freedom in the transverse direction. It is also possible for the transverse guide device to be embodied as a ball rail guide, cf. for example the products offered via
www.boschrexroth.com/ics/cat/?cat=Linear-Motion-Technology-Catalog&m=DE&u=si&o=FilterDesktop&p=g254980&pi=4E760D7D-F909-075C-022C11 D6E9CE5A7B_ICS_82
(Date of access to the website: 18.01.2022).

The requirements for the precision of the transverse guide device define a remaining angular error of the coupling device with the aligning elements held on it. For one proposal, the angular error can be reduced by clamping the linear guide used as the transverse guide device, which can reduce or eliminate play and/or an angular error of the linear guide.

Alternatively or cumulatively, it is possible to use an arresting device after the adjustment for the changeover. By the arresting device the degree of freedom of the transverse guide device in the transverse direction can be fixed. Under certain circumstances, actuating the arresting device also reduces or eliminates any play in the transverse guide device that could lead to an angular error. It is possible, for example, that a manual arresting device is used, cf. in particular
www.boschrexroth.com/de/de/produkte/produktgruppen/lineartechnik/zubehor-und-ersatzteile/klemm-und-bremselemente/hand-klemmelemente-hk-fur-kugelschienenfuhrungen?p=p668420&cat=Linear-Motion-Technology-Catalog&pi=759F85B1-EEB0-8791-71 DFBB05292B14F3_ICS_97&sapCat=LT&o=portal
(Date of access to the website: 18.01.2022),
   or a pneumatic and manually or electronically valve-controlled arresting device is used, cf. in particular
https://www.boschrexroth.com/de/de/produkte/produktgruppen/lineartechnik/zubehor-und-ersatzteile/klemm-und-bremselemente/pneumatische-klemmelemente-Icps-fur-kugelschienenfuhrungen
(Date of access to the website: 18.01.2022).

The aforementioned transverse guide device can be used alone or together with other supports or guide devices to support and guide the unit formed by the mechanical coupling device and the aligning elements. For one embodiment of the band flash butt welding machine, the mechanical coupling device with the aligning elements held on it is additionally guided by a guide device relative to a slide that guides the second clamping element for movement in the direction of the longitudinal axis of the band end. For example, this guide device can be a sliding guide that guides the mechanical coupling device or the bridge part relative to the slide. It is possible, for example, that the bridge part rests on the slide at a distance from the transverse guiding device with a sliding contact in the vertical direction and is additionally supported in this way.

A further option is devoted to generating the movement of the mechanical coupling device with the aligning elements held thereon in the transverse direction. For a first proposal, the mechanical coupling device with the aligning elements held thereon can be moved in the transverse direction by means of a drive driven by an external force. This drive is, for example, a controlled electric drive (open loop control or closed loop control) (in particular a stepper motor whose step size and/or any transmission ratio can be selected according to the desired precision for the movement in the transverse direction direction). It is also possible, for example, that an electronically controlled pneumatic or hydraulic drive is used as the drive.

In another proposal, the mechanical coupling device with the aligning elements attached to it can be moved manually in the transverse direction. For this purpose, a manual actuation means such as a hand wheel, an actuating slide, etc. can be provided, via which the operator can apply the actuating forces for the movement of the coupling device in the transverse direction.

It is possible that the drive driven by the external force or the actuating means for manual actuation act directly on the mechanical coupling device. In a preferred embodiment of the band flash butt welding machine, however, a transmission is arranged in the force flow between the mechanical coupling device with the aligning elements held thereon on the one hand and the drive or the manual actuating element on the other hand. On the one hand, the transmission can be used to gear-up or gear down the forces required for movement to the forces generated by the drive or manual actuator. On the other hand, the actuation kinematics can be influenced by means of a suitable overdrive or underdrive so that the desired precision for the changeover is achieved during the movement of the coupling device in the transverse direction.

All transmissions known from the prior art can be used for the transmission used here. For one proposal, the transmission is a spindle drive. Such a spindle drive can (depending on the selected pitch of the thread and the resulting transmission ratio) enable a very sensitive adjustment of the movement of the coupling device in the transverse direction. On the other hand, the spindle drive can also be used to provide a rigid support for the mechanical coupling device. One of the known thread geometries of the spindle drive can be used for dimensioning the backlash of the transmission and the stiffness of the drive connection. To cite merely one example, the spindle drive may comprise a trapezoidal thread.

It is possible that the clamping elements are separate from the band flash butt welding machine electrodes used for carrying out the welding process. However, for one embodiment a first clamping element and/or a second clamping element (preferably the lower clamping elements) directly form a band flash butt welding machine electrode used for the welding process.

In principle, the clamping elements forming the band flash butt welding machine electrode can be embodied as a single piece, as is the case in embodiments known from the prior art. In one embodiment of the band flash butt welding machine, however, two-part band flash butt welding machine electrodes can be used. In this case, the band flash butt welding machine electrodes have a base body and a contact body. The base body is used to attach the band flash butt welding machine electrode to a foundation or support body or slide of the band flash butt welding machine and comprises the fixing devices required for this purpose, such as bores for fixing screws to pass through. The contact body, on the other hand, is used to establish a contact with the associated band end by a contact surface of the contact body. In order to ensure a large surface contact of the contact surface of the contact body with the associated band end for the electrical connection of the band flash butt welding machine electrode with the band end, grinding of the contact surface with high precision is required. As the contact surface is subjected to wear during operation of the band flash butt welding machine and due to the mechanical and electrical contact conditions in the area of the contact surface, regular regrinding of the contact surface is required, which successively changes the height of the band flash buttwelding machine electrode. Once a predefined amount of the height has been removed, for embodiments known from the prior art the clamping element forming the band flash butt welding machine electrode must be completely replaced. In contrast, for the two-part design of the band flash butt welding machine electrode, only the contact body can be replaced after the separately formed contact body has been worked down to a minimum, while the same base body to which the worked-down contact body was attached can then also be used for a new contact body. This leads to significant cost savings.

In order to bring about the heating required for welding the band ends, a high proportion of the electrical energy applied to the band flash butt welding machine electrodes must be transferred from the band flash butt welding machine electrodes via the end faces of the band ends. If the bridge part creates an electrical connection between the aligning elements (directly or indirectly via other components of the band flash butt welding machine), this electrical connection would form an undesirable bypass for the electrical power supply. As a result of the bypass, the electrical energy applied to the band flash butt welding machine electrodes would not be transmitted completely or as far as possible via the end faces of the band ends. For one proposal the band flash butt welding machine comprises at least one insulation element which separates an electrical connection of the alignment elements via the bridge part.

To mention only a few non-limiting examples,
an insulation element can be arranged between the stop elements and the bridge part and/or
screw insulators can be provided in the area of the screws by means of which the aligning elements are attached to the bridge part, and/or
insulation elements may be arranged between an accessory assembly group comprising the bridge part and a foundation of the band flash butt welding machine and/or
the aforementioned sliding guide may comprise an insulating element to separate the mechanical coupling device from the slide.

In one embodiment the band flash butt welding machine comprises an accessory assembly group. This accessory assembly group can be used, for example, to convert a conventional band flash butt welding machine (and thus also, for example, a band flash butt welding machine as described at the beginning) into a new band flash butt welding machine. The accessory assembly group comprises a bridge part with a first aligning element for a first band end and a second aligning element for a second band end. Furthermore, the accessory assembly group has a fixation area by means of which the accessory assembly group can be attached to a foundation of the (possibly conventional) band flash butt welding machine. To cite merely one example, foundations of known band flash butt welding machines may per se comprise fastening holes that serve to fasten attachment elements such as eyebolts. The attachment elements can be used to attach an attachment element of a crane, which can be used to handle the band flash butt welding machine during transportation, assembly or disassembly. It is also possible that the fixation area of the accessory assembly group interacts with bores of the band flash butt welding machine that are provided for insulating plates of the conventional band flash butt welding machine or for fastening stop rails and the like.

Finally, the accessory assembly group comprises a transverse guide device via which the fixation area is coupled to the bridge part. With regard to the design of the transverse guide device, what was previously said about the transverse guide device of the band flash butt welding machine applies accordingly.

The accessory assembly group may also comprise other previously mentioned devices, components or features. In particular, the bridge part
forms a mechanical coupling device and/or
comprises first and second bridge sections with a recess arranged therebetween and/or
comprises an arresting device by means of which the degree of freedom of the transverse guide device in the transverse direction can be fixed and/or
comprises a guide device for a guidance relative to a slide which guides the second clamping element for the movement in the direction of the longitudinal axis of the band end, and/or
comprises a drive driven by an external force or a manual actuating means for the movement of the actuating part in the transverse direction and/or
comprises a transmission or a spindle drive.

It is possible for the accessory assembly group to be mounted with the (in some circumstances conventional) band flash butt welding machine without changing the position of the components of the band flash butt welding machine. For one proposal, however, the accessory assembly group comprises at least one intermediate body. The intermediate body can be arranged between a foundation of the band flash butt welding machine and a tool of the band flash butt welding machine, an actuator for a clamping jaw and/or the bridge part, the aligning element or the clamping elements and/or the band flash butt welding machine electrode, whereby the working height can be increased in relation to the foundation. This increase in the working height allows, for example, additional installation space to be available for the design of the band flash butt welding machine electrode, so that it can also be embodied as two parts with a base body and a contact body, as explained above.

A further embodiment is based in particular on the realization that, during operation of the band flash butt welding machine, the band ends have to be clamped between first and second clamping elements, the first and second clamping elements being formed by upper and lower clamping jaws, between which the band ends are clamped. At least one of the two clamping jaws is embodied as a multifunctional band flash butt welding machine electrode, the electrical energy of which is transmitted to the band ends as a result of being pressed against the band ends in order to create the electric arc and provide the welding between the end faces of the band ends. When using the band flash butt welding machine electrode for several operating cycles, the contact surface of the band flash butt welding machine electrode with the band end is worn as a result of the mechanical interaction and in particular as a result of a burn-off. Accordingly, the contact surface of the band flash butt welding machine electrode is successively worn down and the height of the band flash butt welding machine electrode is successively reduced. If the wear of the band flash butt welding machine electrode causes the height of the contact surface of the band flash butt welding machine electrode to decrease by a critical height difference ΔH, the band flash butt welding machine electrode has to be replaced. The reason for this may be that the other clamping jaw can no longer compensate for the reduced height ΔH, which may result in the band flash butt welding machine electrode no longer being pressed against the band end with the predetermined pressing force, which increases the contact resistance between the band flash butt welding machine electrode and the band end in an undesirable manner, and/or the band end is no longer sufficiently clamped and thus no longer fixed. It is also possible that the extension plane is lowered by the amount ΔH compared to other contact surfaces of the band end (for example in the area of an aligning element, stop body, support body or a band back stop), so that the band end has to be elastically deformed to an undesirable extent between the contact surface of the band flash butt welding machine electrode on the one hand and the other contact surface. If the band flash butt welding machine electrode is replaced after wearing out to the extent of the critical height change ΔH, the residual material of the band flash butt welding machine electrode reduced by the height ΔH can no longer be used.

Against this background, in one embodiment the band flash butt welding machine electrode is embodied as at least two parts. In this case, the band flash butt welding machine electrode comprises a base body and a contact body.

The base body is used, for example, to support the flash butt welding machine electrode on a foundation, whereby the base body (for example by means of a flange of the base body) can also enable a fastening, in particular by screwing, to the foundation. Alternatively or additionally, the base body has a connection for electrical contacting in order to transfer the electrical energy required for the welding process into the base body.

The contact body has a flat contact surface that should be in contact with the band end over the largest contact area possible in order to be able to transfer the electrical energy introduced into the base body and transmitted to the contact body to the band end with the lowest possible contact resistance.

The contact surfaces between the base body and the contact body can be of any configuration. It is possible, for example, that the contact surfaces are flat and horizontally oriented. However, it is also possible for the contact surfaces between the base body and the contact body to deviate from a plane as desired. To give just one example, the contact surfaces can be embodied as a toothed rack so that the meandering back and forth inclined contact surface is increased and/or so that a high pressing force between the base body and the contact body due to the wedge effect of the meshing teeth is possible. However, any other shape of contact surfaces is also possible.

Due to the two-part design of the band flash butt welding machine electrode with the base body and the contact body, the contact body can be removed from the base body after the contact body has worn by a critical height ΔH and a new contact body can be fitted to the base body. This means that the entire band flash butt welding machine electrode does not have to be replaced due to wear, as is the case in the state of the art. Instead, it is sufficient to replace the contact body, which means that the material of the base body can be used again and again. In this way, a significant saving in material can thus be achieved.

Alternatively, after the contact body has been worn by a critical height ΔH, the contact body can continue to be used, but a base body can then be used whose height is greater by the height difference ΔH than the height of the previously used base body. This can also result in significant material savings.

There are various possibilities for the type of connection between the base body and the contact body. In one proposal, the base body and the contact body are connected to each other via fixing screws. The fixing screws provide the contact pressure between the base body and the contact body in order to provide a small contact resistance. Alternatively or cumulatively, the base body and the contact body can be connected to each other via locating pins, which defined the relative position of the base body and the contact body. While in principle any orientation of the fixing screws and/or locating pins is possible, these are preferably oriented vertically to the contact surfaces between the base body and the contact body and parallel to each other.

It is possible that the band flash butt welding machine electrode (in addition to any fixing screws and locating pins) consists of the base body and the contact body only. In another proposal, the flash butt welding machine electrode comprises at least three parts. In this case, the band flash butt welding machine electrode comprises a base body, a contact body and at least one compensating body. The compensating body is used to compensate for wear of the contact body in the height direction as follows: First, a flash butt welding machine electrode is used, which consists exclusively of the base body and the contact body. If the contact body is worn by the critical height ΔH, the contact body would have to be replaced with a new contact body. For this proposal, however, the contact body is still used. However, this contact body is disassembled from the base body and the compensating body is mounted between the base body and the contact body. The compensating body has a height ΔH, which has the effect that the contact surface of the contact body for the band is again arranged at the initial height in the band flash butt welding machine electrode now formed with the base body, the contact body and the compensating body. By using the compensating body, the service life of one and the same contact body can be doubled. It is possible that after further wear of the contact body by the height ΔH, an additional corresponding compensating body is then assembled or the previously used compensating body is removed and a compensating body with twice the height 2ΔH is used, which means that the same contact body can then be used again, etc.

In the present context, as explained above, the at least one compensating body can be arranged between the base body and the contact body. It is also possible that the compensating body is arranged between the base body and the foundation. It is also possible that at least one compensating body is arranged between the foundation and the base body, while at least one compensating body is also arranged between the base body and the contact body. If the compensating body is located between the base body and the foundation, the compensating body can also provide an insulation to prevent electrical energy from being transferred or bypassed via the foundation. In this case, the compensating body can merely comprise an insulating layer or the whole compensating body can be made of an insulating material.

In principle, there are many possibilities for the geometric design of the compensating body, wherein the shape of the compensating body is preferably adapted to the contact surfaces with the foundation, the base body or the contact body. Preferably, the compensating body is embodied as a plate. In particular, the compensating body has a plate thickness that corresponds to the critical extent ΔH of the wear. Preferably, the plate height is less than 10 mm, in particular less than 8 mm, less than 6 mm, less than 5 mm or even less than 4 mm.

There are also a variety of options for the geometric design of the contact body. In one proposal, the contact body is embodied as a plate or cuboid. The contact body can comprise a height that is less than 60 mm, in particular less than 50 mm or less than 40 mm or even less than 30 mm.

For a further proposal, the contact body protrudes beyond the base body and/or a compensating body arranged between the base body and the contact body when viewed from above in the direction of the longitudinal axis of the band. This dimensioning of the contact body, the base body and/or the compensating body has the effect that the contact body can reach very close to the end faces of the band ends, which is advantageous for introduction the energy, for the support of the band ends and for the welding process. As a result of the protrusion of the contact body, there is a step back below the contact body in the transition area to the compensating body and/or base body. This step back can be used advantageously to enable a movement of a tool of the band flash butt welding machine. If, for example, the weld seam is reworked using a planer, a planer blade can move through a gap between the facing end faces of two contact bodies of the two band flash butt welding machine electrode, while a larger holder for the planer blade can pass through the enlarged gap between the base bodies in the area of the steps back.

It is possible that, in a corresponding plan view, the base body protrudes in a direction transverse to the longitudinal axis of the band over the base body and/or a compensating body arranged between the base body and the contact body. Such a protrusion can be used to form a flange in the area of which the base body and/or compensating body can be screwed to the foundation of the flash butt welding machine. It is also possible that a projection (preferably arranged on the opposite side) serves to support the base body and thus the band flash butt welding machine electrode on another part of the band flash butt welding machine in order to define the position of the band flash butt welding machine electrode relative to the other components of the band flash butt welding machine, preferably in a direction transverse to the longitudinal axis of the band ends.

An electrode set for the flash butt welding machine can also be used. The electrode set then comprises a band flash butt welding machine electrode, as explained above. The electrode set contains at least two base bodies having different heights. This will be explained for an example in which a first base body comprises the height H required to use a new contact body in the flash butt welding machine. In contrast, the second base body has a height that results from the sum of the height H and the critical height due to wear ΔH. Initially, the band flash butt welding machine electrode is operated with the first base body and a new contact body until the wear ΔH has occurred at the contact body. The first base body is removed from the contact body. The same contact body is then fitted to the second base body. As a result of the increased height of the second base body, the contact surface of the already worn contact body is then at the starting height of the non-worn contact body on the first base body. Further operation of the band flash butt welding machine can then take place with the already worn contact body. It goes without saying that a third, fourth, . . . base body with a height respectively increased by ΔH can also be used.

Alternatively or additionally, the electrode set can also contain compensating bodies with different heights, whereby the heights can then differ from each other by the height ΔH.

Advantageous developments of the invention result from the claims, the description and the drawings.

The advantages of features and of combinations of a plurality of features mentioned at the beginning of the description only serve as examples and may be used alternatively or cumulatively without the necessity of embodiments according to the invention having to obtain these advantages.

The following applies with respect to the disclosure—not the scope of protection—of the original application and the patent: Further features may be taken from the drawings, in particular from the illustrated designs and the dimensions of a plurality of components with respect to one another as well as from their relative arrangement and their operative connection. The combination of features of different embodiments of the invention or of features of different claims independent of the chosen references of the claims is also possible, and it is motivated herewith. This also relates to features which are illustrated in separate drawings, or which are mentioned when describing them. These features may also be combined with features of different claims. Furthermore, it is possible that further embodiments of the invention do not have the features mentioned in the claims which, however, does not apply to the independent claims of the granted patent.

The number of the features mentioned in the claims and in the description is to be understood to cover this exact number and a greater number than the mentioned number without having to explicitly use the adverb “at least”. For example, if an element is mentioned, this is to be understood such that there is exactly one element or there are two elements or more elements. Additional features may be added to these features, or these features may be the only features of the respective product.

The reference signs contained in the claims are not limiting the extent of the matter protected by the claims. Their sole function is to make the claims easier to understand.

### BRIEF DESCRIPTION OF THE DRAWINGS

In the following, the invention is further explained and described with reference to preferred embodiments shown in the figures.

FIG. 1 highly schematically shows a band flash butt welding machine according to the state of the art.

FIG. 2 highly schematically shows a band flash butt welding machine.

FIG. 3 shows a front view of a band flash butt welding machine.

FIG. 4 shows the band flash butt welding machine according to FIG. 3 in a horizontal section IV-IV for the section view marked in FIG. 3.

FIG. 5 shows a top view of an accessory assembly group for a band flash butt welding machine.

FIG. 6 shows a front view of the accessory assembly group as shown in FIG. 5.

FIG. 7 shows the accessory assembly group according to FIGS. 5 and 6 in a view from the left.

FIG. 8 shows an accessory assembly group with band ends arranged on it and intermediate bodies with a removed supporting plate in a spatial representation.

FIG. 9 shows a front view of the accessory assembly group with band ends and intermediate bodies as shown in FIG. 8

FIG. 10 shows a section X-X of the accessory assembly group with band ends and intermediate bodies in the section marked in FIG. 9.

FIG. 11 shows the accessory assembly group with band ends and intermediate bodies as shown in FIGS. 8 to 10 with the supporting plate removed in a view from the left.

FIG. 12 shows a top view of the accessory assembly group with band ends and clamping elements, band flash butt welding machine electrodes and actuators.

FIG. 13 shows a schematic top view of two flash butt welding machine electrodes.

FIG. 14 shows a front view of the flash butt welding machine electrodes as shown in FIG. 13.

FIG. 15 shows the band flash butt welding machine electrodes according to FIGS. 13 and 14 in a vertical section XV-XV.

FIG. 16 shows the band flash butt welding machine electrodes according to FIGS. 13 to 15 in a view from below.

FIG. 17 shows a band flash butt welding machine with the band flash butt welding machine electrodes according to FIGS. 13 to 16 in a plan view.

FIG. 18 shows a vertical section XVIII-XVIII of the band flash butt welding machine according to FIG. 17.

FIG. 19 shows a detail XIX of the vertical section of the band flash butt welding machine according to FIG. 18.

FIG. 20 schematically shows a restoration of a band flash butt welding machine electrode after wear by replacing the contact body.

FIG. 21 schematically shows a restoration of a band flash butt welding machine electrode after wear by replacing the base body.

FIG. 22 schematically shows a restoration of a band flash butt welding machine electrode after wear by using a compensating body.

### DETAILED DESCRIPTION

In the figures, components which correspond to each other or are similar to each other in terms of their geometries and/or functions are in some cases labelled with the same reference numbers, whereby these can then be distinguished from each other by the supplementary letter a, b, . . . . If a reference is made to such a component by using the reference number without the supplementary letter, this can mean one single component, any number of these components or all of these components.

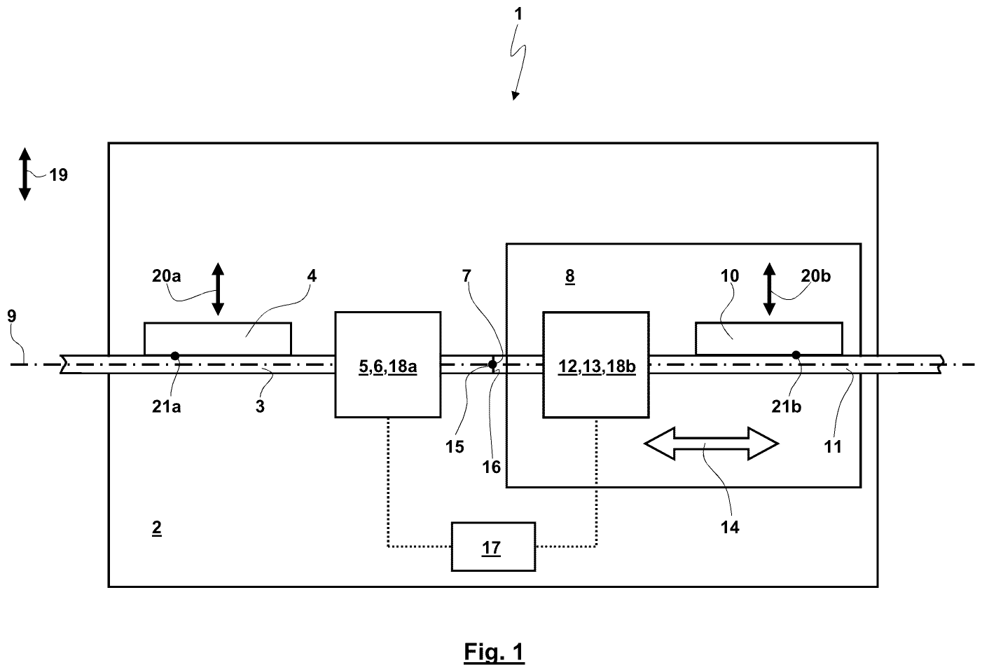

FIG. 1 shows a band flash butt welding machine 1 according to the prior art. The band flash butt welding machine 1 has a foundation 2, which can be embodied massive or as a supporting structure. A first band end 3 is aligned by a first aligning element 4 with an alignment rail and support bolts and is clamped between first clamping elements 5a, 5b, at least one of the first clamping elements 5 forming a first band flash butt welding machine electrode 6. The first band end 3 has a first end face 7.

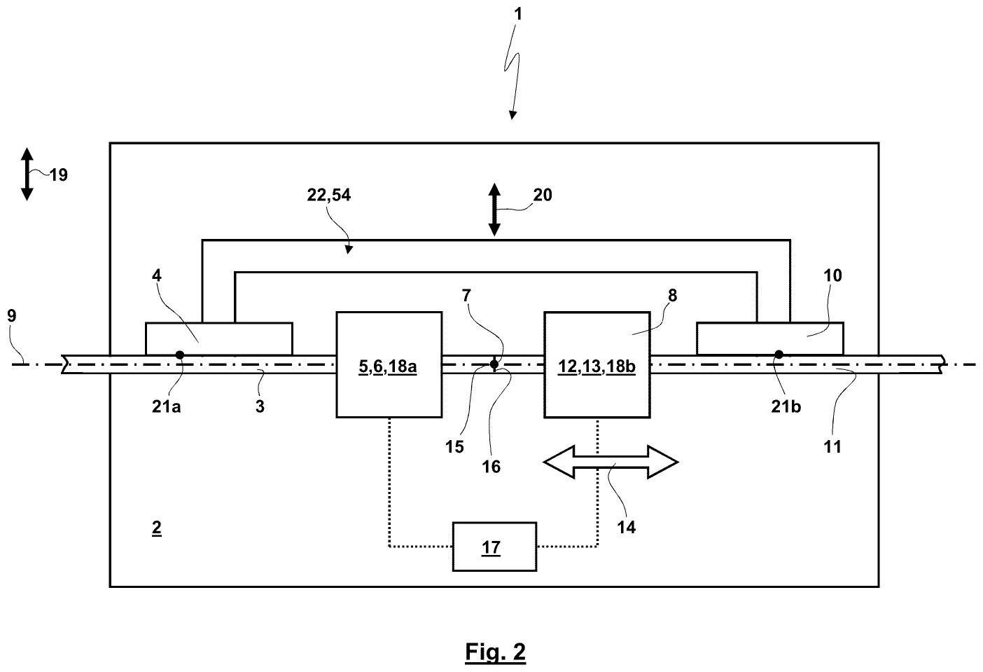

By means of a drive (not shown here) a slide 8 can be moved with a movement 14 in the direction of a longitudinal axis 9, which corresponds to the longitudinal axis 9a of the first band end 3. A second aligning element 10 is attached to the slide 8. The second alignment element 10 is aligned with a second band end 11. The second band end 11 is clamped between second clamping elements 12a, 12b, at least one of the second clamping elements 12 forming a second band flash butt welding machine electrode 13. The movement 14 of the slide 8 along the longitudinal axis 9 is accompanied by a corresponding movement of the second clamping elements 12, the second band flash butt welding machine electrode 13, the second aligning element 10 and the second band end 11. The second band end 11 has a second end face 15. In the operating position shown in FIG. 2, the end faces 7 and 15 are in contact with each other or are connected to each other by a weld seam 16. The band flash butt welding machine 1 has at least one electronic control unit 17. On the one hand, the electronic control unit 17 controls the electrical energization of the band flash butt welding machine electrodes 6, 13. On the other hand, the control unit 17 controls the operation of actuators 18a, 18b for actuating the clamping elements 5, 12 and the drive for generating the movement 14.

In FIG. 1, the longitudinal axis 9 indicates the longitudinal axis of the band ends 3, 11, which for a embodiment of the band as a saw band corresponds to the band running direction of the saw band during operation of the same for sawing a workpiece. In FIG. 1, on the other hand, a transverse direction 19 indicates a direction transverse to the longitudinal axis 9 in a horizontal plane, the transverse direction 19 corresponding to the direction in which the weld seam 16 extends.

For a changeover of the band flash butt welding machine 1, it is necessary to provide adjustments 20a, 20b for the alignments of the aligning elements 4, 10. The adjustments 20 must be provided in particular to ensure that aligning surfaces 21a, 21b (here vertical surfaces) of the alignment elements 4, 10 are arranged in one plane and in the correct position in the transverse direction 19, which depends on the type of the at least one band forming the band ends 3, 11.

Here, the adjusted alignment of the alignment elements 4, 10 is fixed by means of screw connections to the foundation 2 or the slide 8.

FIG. 2 shows a band flash butt welding machine 1. For this band flash butt welding machine 1 what was said above for the known band flash butt welding machine 1 according to FIG. 1 and for the band flash butt welding machines of the prior art can apply until further notice.

For this embodiment, the two aligning elements 4, 10 are rigidly connected to each other via a bridge part 22. It is possible that the alignment of the aligning elements 4, 10 relative to each other is adjusted by an adjustment device or screws for an initial assembly or for a fine or a subsequent adjustment independent of the changeover. For a changeover, however, only a single adjustment 20 of the bridge part 22 and with it of the aligning elements 4, 10 is made, wherein the alignment of the aligning elements 4, 10 to one another cannot change during the adjustment 20. In this case, the second aligning element 10 is not held on a slide 8. Rather, a slide 8 exclusively carries the second clamping elements 12, the band flash butt welding machine electrode 13 embodied as a separate element or the band flash butt welding machine electrode 13 integral with the second clamping elements 12 and the second actuator 18b. If there is a movement 14 of the slide 8 with the clamping elements 12, the band flash butt welding machine electrode 13 and the actuator 18 while the second band end 11 is clamped by the clamping elements 12, there is a sliding movement of the second band end 1 relative to the second aligning element 10, in particular in the area of the aligning surface 21b.

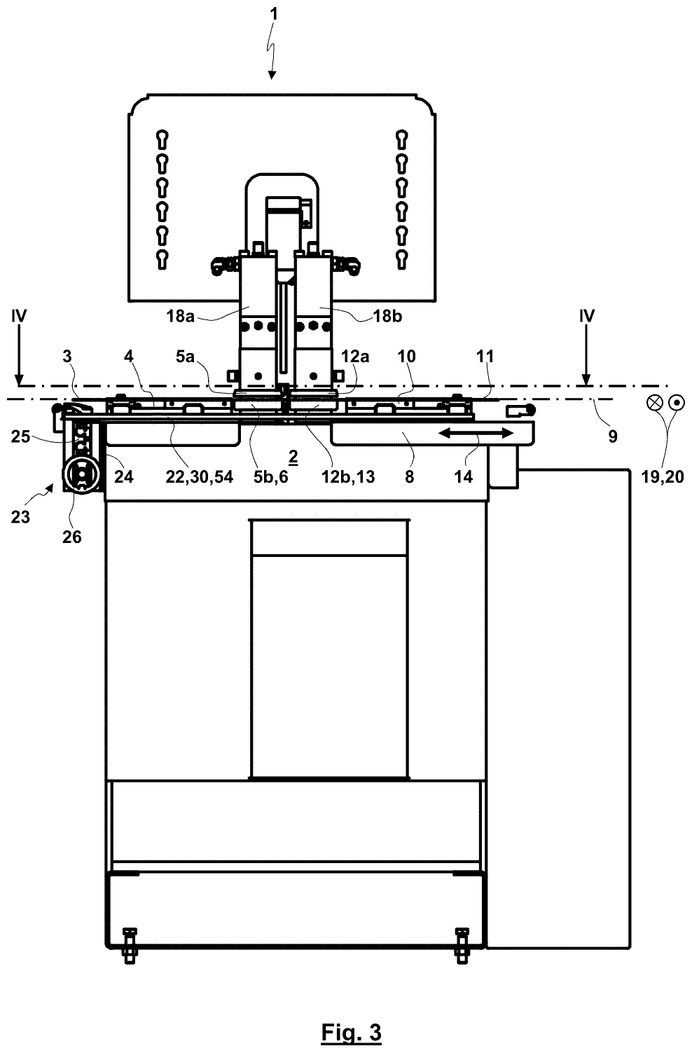

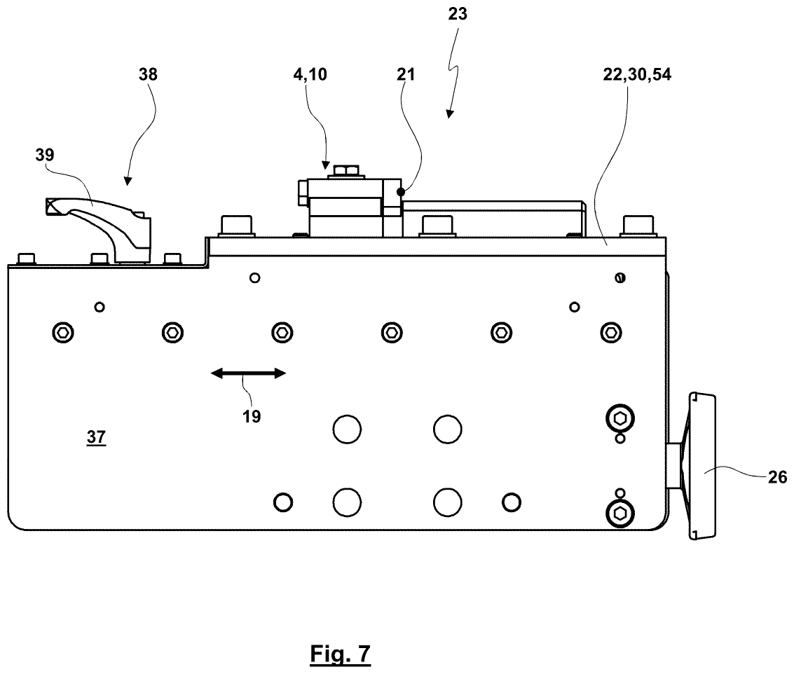

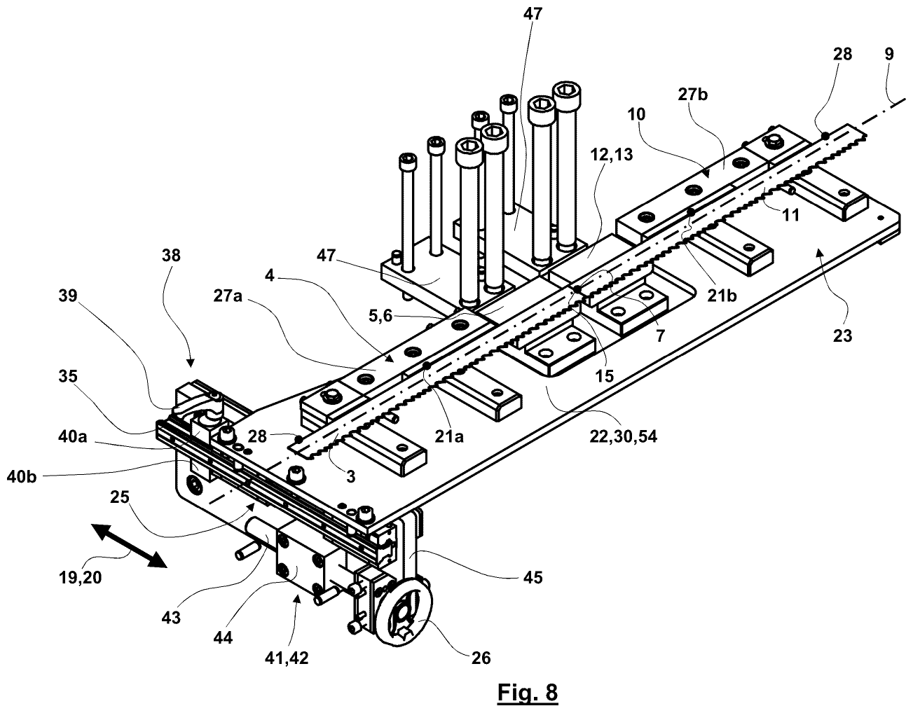

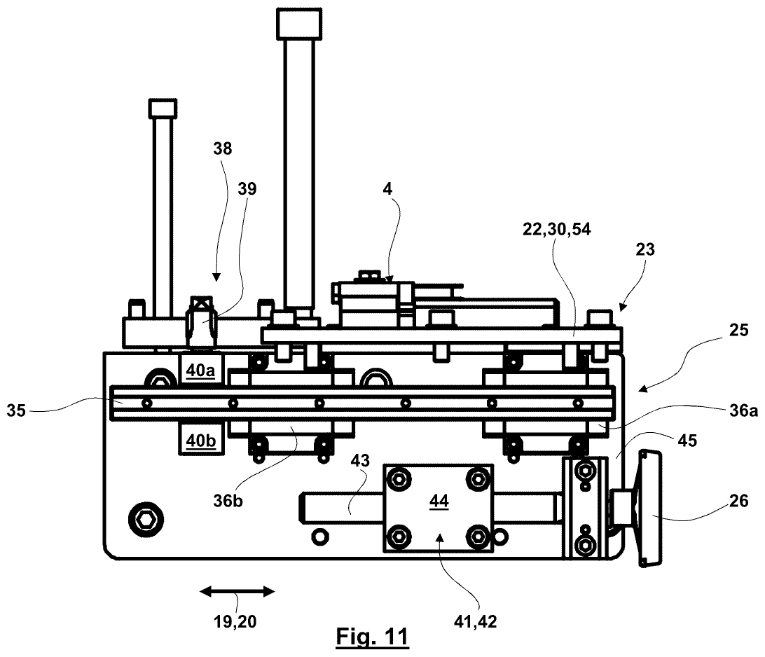

FIGS. 3 to 12 show a particular embodiment, in which the band flash butt welding machine is formed by attaching an accessory assembly group 23 to a conventional band flash butt welding machine.

FIG. 3 shows a front view of the band flash butt welding machine 1 with the accessory assembly group 23. A foundation 2 can be seen here. A slide 8 can perform a movement 14 relative to the foundation 2. This movement 14 is also carried out by the tower-like actuators 18b with an upper and lower clamping element 12a, 12b and the second band flash butt welding machine electrode 13 formed, The accessory assembly group 23 comprises
the bridge part 22 with the aligning elements 4, 10,
a fixation area 24 for attaching the accessory assembly group 23 to the foundation 2 of the band flash butt welding machine 1 (here in the side area of the same),
a transverse guide device 25, by which the bridge part 22 is guided in the transverse direction 19 relative to the fixation area 24,
and a hand actuating member, here in the form of a hand wheel 26, for bringing about the relative movement of the bridge part 22 with respect to the fixation area 24 in the transverse direction 19
   (see also the following figures and associated description).

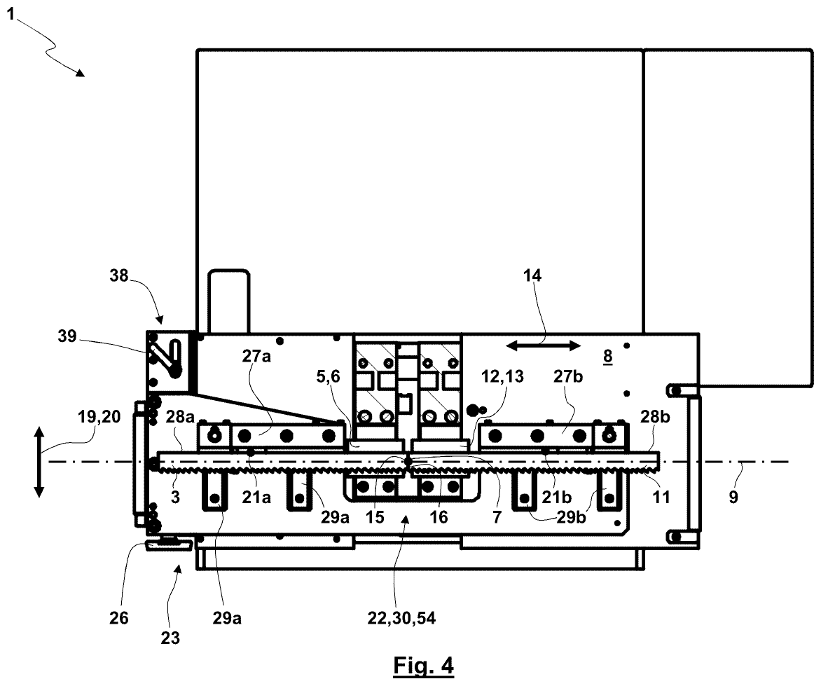

In the horizontal section IV-IV according to FIG. 4, it can be seen that the aligning elements 4, 10 each have a stop body 27a, 27b, which form the aligning surfaces 21a, 21b for the band backs 28a, 28b of the band ends 3, 11. In addition, the aligning elements 4, 10 comprise support bodies 29a, 29b, which extend from the stop bodies 27 below the band ends 3, 11 in the transverse direction 19 and on which the band ends 3, 11 rest with their undersides. As can be seen in FIG. 4, the aligning elements 3, 11 each comprise a pair of support bodies 29 of this type, which are arranged at a distance from one another in the direction of the longitudinal axis 9.

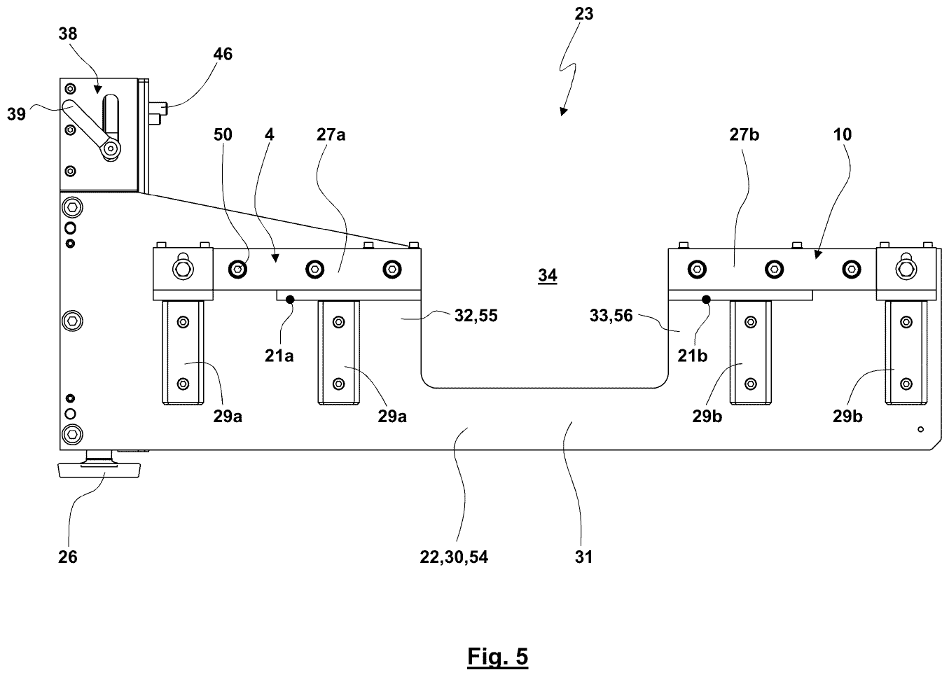

FIGS. 5 to 7 show different views of the accessory assembly group 23. In the top view according to FIG. 5 it can be seen that the bridge part 22 is embodied as a bridge plate 30. In a first approximation, the bridge part 22 is U-shaped with a base leg 31 and two side legs 32, 33. The base leg 31 and the side legs 32, 33 delimit a recess 34 that is open in one direction. The alignment elements 4, 10 are arranged in the area of the side legs 32, 33. The stop bodies 27 and the aligning surfaces 21 formed by these are arranged parallel to the base leg 31, while the support bodies 29 are arranged vertically to the base leg 31.

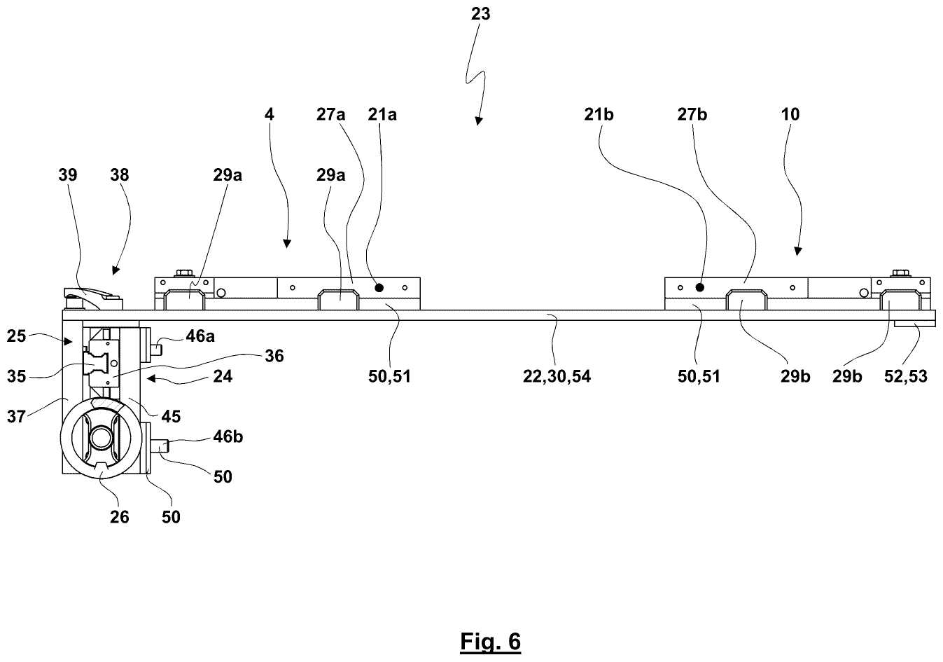

In FIG. 6 it can be seen that the transverse guide device 25 comprises a guide rail 35 extending in the transverse direction 19, the cross-section of which is positively enclosed by two guide bearings 36. The transverse guide device 25 allows a relative movement of the guide bearings 36 along the guide rail 35 in the transverse direction 19. For the illustrated embodiment example, the guide bearings 36 are fastened to the fixation area 24, while the guide rail 35 is fastened to a vertically oriented supporting plate 37 fastened to the bridge part 22. Preferably, the guide bearings 36 are clamped in a manner known per se to reduce play in the transverse guide device 25. Preferably the transverse guide device 25 is embodied as a ball rail guide. If the attachment assembly group 23 is fastened to the foundation 2 via the fastening area 24, the movement guided by the transverse guide device 25 in the transverse direction 19 can be used to bring about the adjustment 20 of the bridge part 22 with the alignment elements 4, 10 as a unit.

Furthermore, the accessory assembly group 23 has an arresting device 38, which can be manually actuated by the operator via an arresting lever 39 for the embodiment shown. For the illustrated embodiment of the arresting device 38, manual actuation of the arresting lever 39 can be used to tighten arresting jaws 40a, 40b (see FIG. 11) in such a way that the arresting jaws 40 are clamped with the guide rail 35, whereby the degree of freedom of the transverse guiding device 25 is arrested in the transverse direction 19. The arresting device 38 is released when the changeover is to take place. Once the adjustment 20 has been made to the desired extent, the arresting device 38 is arrested again.

In the example shown, the adjustment 20 in the transverse direction 19 is effected by manually turning the hand wheel 26. A transmission 41, in this case a spindle drive 42, is actuated by the hand wheel 26. The spindle drive 42 comprises a spindle 43, which is rotationally fixed to the handwheel 26 and is rotatably mounted in bearings, and a spindle nut 44, which comprises only one degree of freedom in transverse direction 19 due to the transverse guide device 25. For the illustrated embodiment, the bearings are attached to the fixation area 24, while the spindle nut 44 is attached to the supporting plate 37.

The fixation area 24 has a mounting plate 45, which on the one hand supports the aforementioned bearings for the spindle 43 and the guide bearings 36 and on the other hand supports mounting bolts 46a, 46b, which can be screwed to threaded holes in the foundation 2. These can be threaded holes for eyebolts, via which the band flash butt welding machine can be linked to a hook of a crane in accordance with the state of the art.

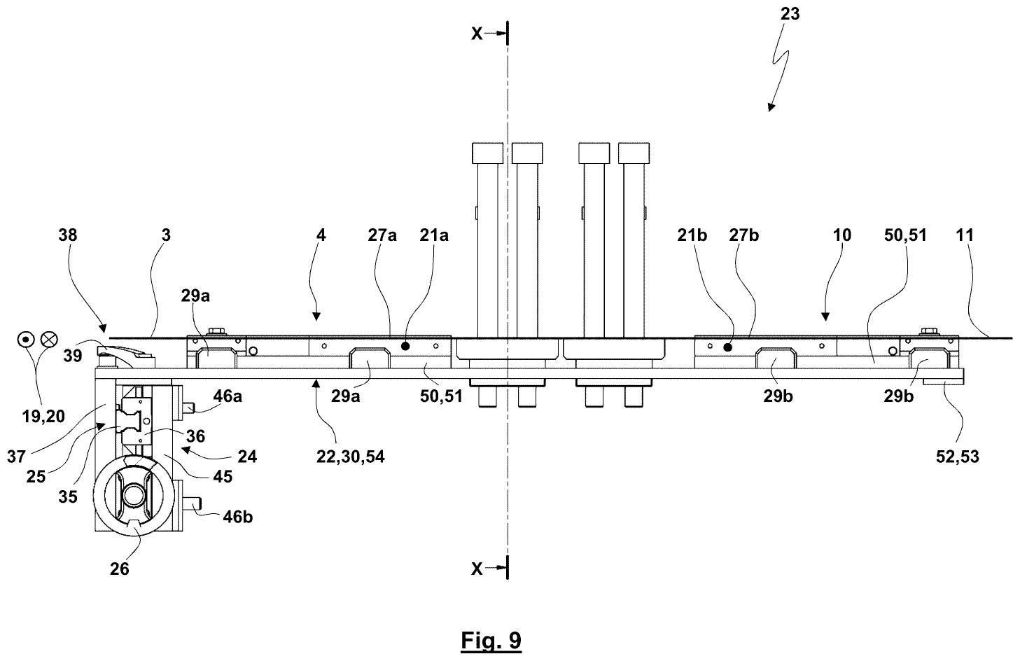

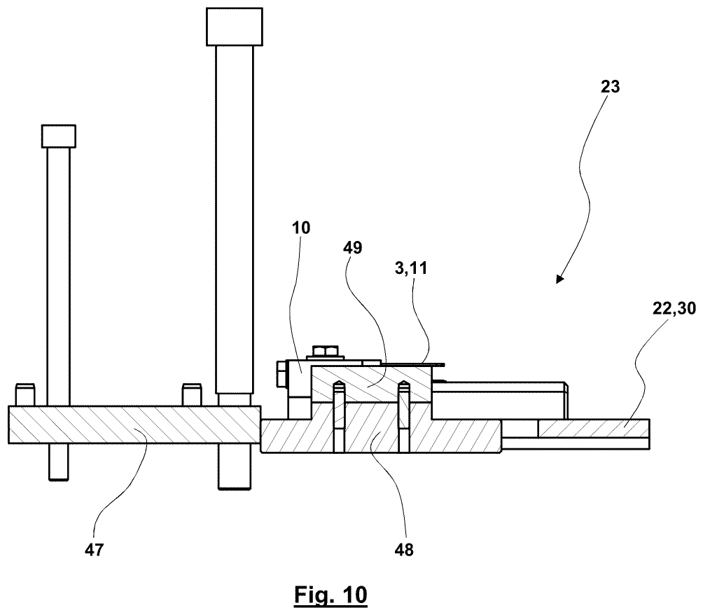

It is also possible that by the accessory assembly group 23 the working plane, in which the band ends 3, 11 and the contact surfaces with the aligning elements 4, 10 as well as the areas of the interaction with the clamping elements 5, 12 and the band flash butt welding machine electrodes 6, 13 as well as a tool, for example for deburring, are arranged is higher than the working plane of the band flash butt welding machine known from the prior art, which can reflect in the dimensions of the bridge part 22 and of the aligning elements 4, 10 as well as of the lower clamping elements 5, 12 and of band flash butt welding machine electrodes 6, 13 in the height direction. If it is also necessary to raise the upper clamping elements 5, 12 and/or the associated actuators 18a, 18b for this the purpose, additional intermediate bodies 47 can be used in the accessory assembly group 23, on which the actuators 18a, 18b and the associated upper clamping elements 5, 12 are arranged (see FIG. 9, FIG. 10). This raising of the working plane also allows the lower clamping elements 5, 12 and the band flash butt welding machine electrodes 6, 13 formed by them to be embodied as two parts with a base body 48 and a contact body 49. The base body 48 and the contact body 49 are screwed together to form a rigid unit. The base body 48 is used for a fastening to the foundation 2 or the slide 8, while the contact body 49 is used for contacting the band ends 3, 11 and for transmitting the electrical energy of the band flash butt welding machine electrodes 6, 13.

To establish the electric arc between the end faces 7, 15 of the band ends 3, 11, care must be taken to ensure that no short circuit occurs between the band flash butt welding machine electrodes 6, 13 via the bridge part 22 or the attachment group 23. For this purpose, insulation elements 50 must be provided on the path between the band flash butt welding machine electrodes 6, 13 via the adjacent band ends 3, 11, the aligning elements 4, 10 and the bridge part 22 to interrupt the short circuit.

In the example shown, insulation elements 50a are embodied as plastic plates 51, which are arranged between the aligning elements 4, 10 and the bridge part 22. The screws used to fasten the aligning elements 4, 10 to the bridge part 22 have screw insulators that form insulation elements 50b. Furthermore, the fixation area 24 can be supported on the foundation 2 via plastic plates 51, which form insulation elements 50c. For the illustrated embodiment, the accessory assembly group 23 also has a plastic plate 52, which forms a further insulation element 50d. Via the plastic plate 52, the bridge part 22 of the accessory assembly group 23 is additionally supported in a vertical direction in the end region on the side facing away from the transverse guide device 25 and the fixation area 24 in a sliding manner to enable movement in the transverse direction 19. In this way, a further guide device 53 for the accessory assembly group 23 is provided. Here, the guide device 53 is embodied as a sliding guide. It is possible that the plastic plate 52 is supported on the upper side of the slide 8 of the band flash butt welding machine 1. In this case, the guide device 53 not only ensures a sliding relative movement in the transverse direction 19 for the adjustment 20, but also a relative movement parallel to the longitudinal axis 9 during the movement of the slide 8.

Here, the aligning elements 4, 10 are coupled via a mechanical coupling device 54, which is formed with the bridge part 22 for the embodiment shown.

In the bridge part 22, the two side legs 32, 33 each form bridge part sections 55, 56, which are connected to each other via the base leg 31. The aligning elements 4, 10 are attached to the bridge part sections 55, 56. The mechanical coupling is then provided by the base leg 31, which forms a kind of coupling web.

For the description of the figures, reference has been made to any band ends 3, 11, so that they can be, for example, band ends of any two bands with any longitudinal extension, any cross-sections and any materials. Preferably, the band ends 3, 11 are saw band ends of a saw band bent and welded to an endless ring.

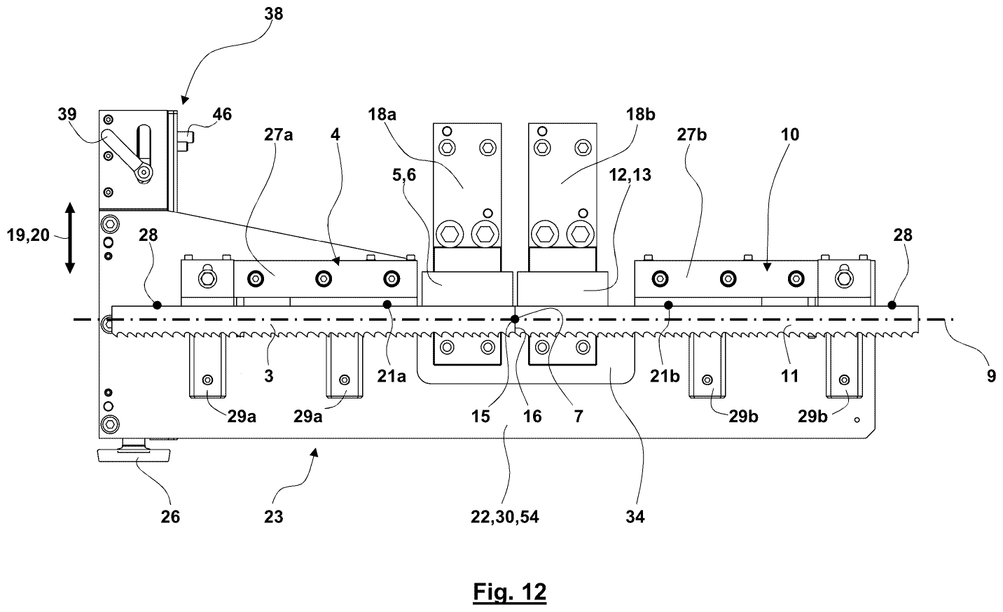

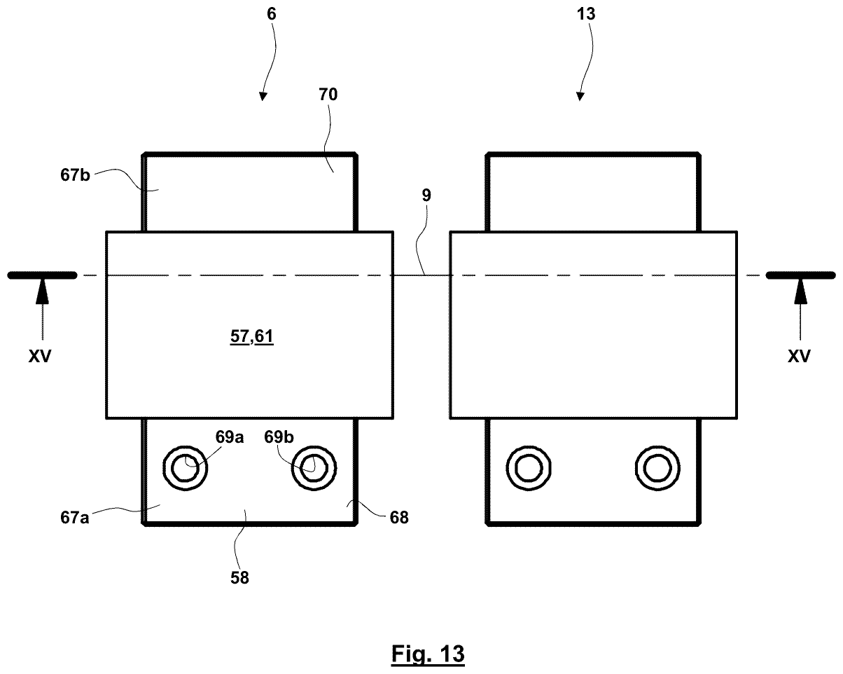

FIGS. 13 to 16 show band flash butt welding machine electrodes 6, 13 in different views. The design of the band flash butt welding machine electrodes 6, 13 is explained by way of example with reference to the band flash butt welding machine electrode 6, using the reference signs only for the band flash butt welding machine electrode 6, while the same can apply to the band flash butt welding machine electrode 13 having an identical design.

The band flash butt welding machine electrodes 6, 13 have a base body 57 and a contact body 58, which are divided horizontally and in a dividing plane and which contact each other over their entire surface via contact surfaces 59, 60. On its upper side, the contact body 58 forms a contact surface 61 on which the band end 3, 11 rests. On the lower side, the base body 57 forms a contact surface 62, by which the band flash butt welding machine electrode 6, 13 is supported directly or indirectly on the foundation 2 or the slide 8.

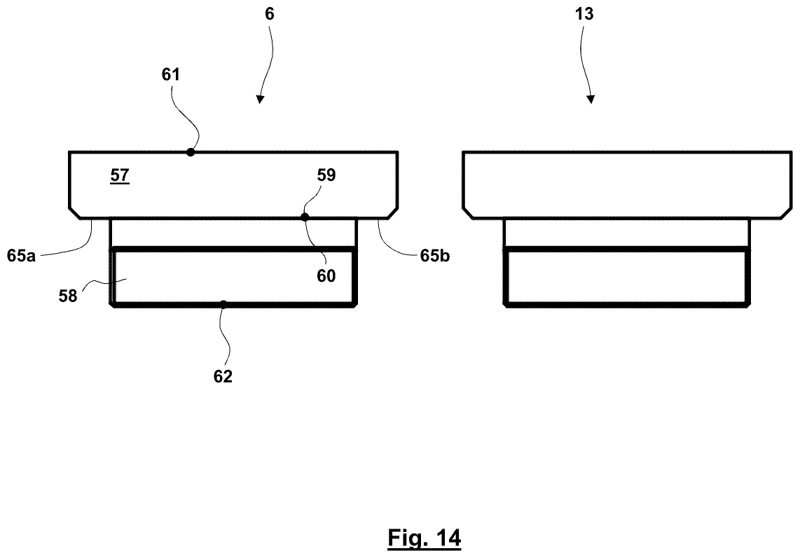

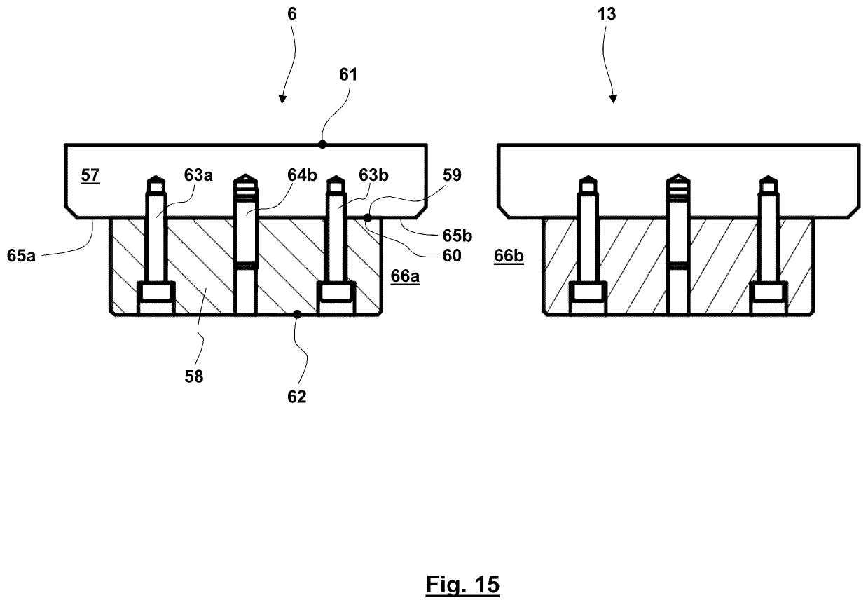

The contact body 58 is embodied as a cuboid. It is possible that the edges of the cuboid are rounded or have a chamfer (see FIG. 15).

The contact body 58 is attached to the base body 57 via fixing screws 63a, 63b, 63c, 63d. The relative position between the base body 57 and the contact body 58 is defined by locating pins 64a, 64b. The fixing screws 63 and the locating pins 64 extend vertically to the contact surfaces 59, 60. The locating pins 64a, 64b are preferably arranged at a relatively large distance from one another. For the embodiment shown the locating pins 64a, 64b are oriented along a transverse axis which is oriented transversely to the longitudinal axis 9. With regard to an exemplary hole pattern for the locating pins 64 and the fixing screws 63, reference is made to FIG. 16.

The bores in the contact body 58 are embodied as blind holes, the bores for the fixing screws 63 being threaded blind holes. In contrast, the bores in the base body 57 are through-holes. The heads of the fixing screws 63 are countersunk in the base body 57 so that they do not protrude from the contact surface 62.

As can be seen in FIG. 16, the contact body 58 is dimensioned in the direction of the longitudinal axis 9 in such a way that it forms a projection 65a, 65b on both sides of the base body 57. As a consequence, the band flash butt welding machine electrodes 6, 13 each form a recess 66a, 66b in a vertical section that runs in the direction of the longitudinal axis 9 (see FIG. 15). In a horizontal plane and transverse to the longitudinal axis 9, the base body 58 protrudes with the protrusions 67a, 67b beyond the contact body 58 in both directions. Here, the protrusion 67a forms a flange 58 on the side facing the user of the band flash butt welding machine 1, the flange 58 comprising bores 69a, 69b. The band flash butt welding machine electrodes 6, 13 can be screwed to the foundation 2 or the slide 8 via the bores 69 of the flange 68.

The protrusion 67b forms an alignment and/or positioning element 70, the function of which will be explained below.

While it is basically possible that the base body 58 is also embodied as a cuboid, the base body 58 preferably has a lower height in the region of at least one projection 67a, 67b than in the region of the contact surface 59. It is also possible that the contact body 58 merges into the projection 67a, 67b via a step back formed by the base body 57.

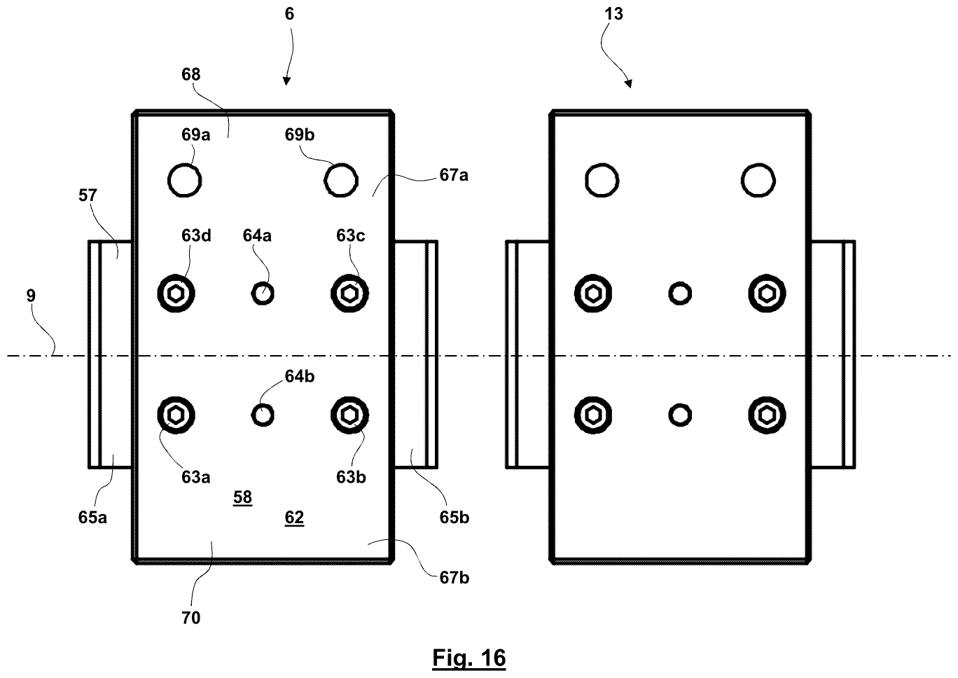

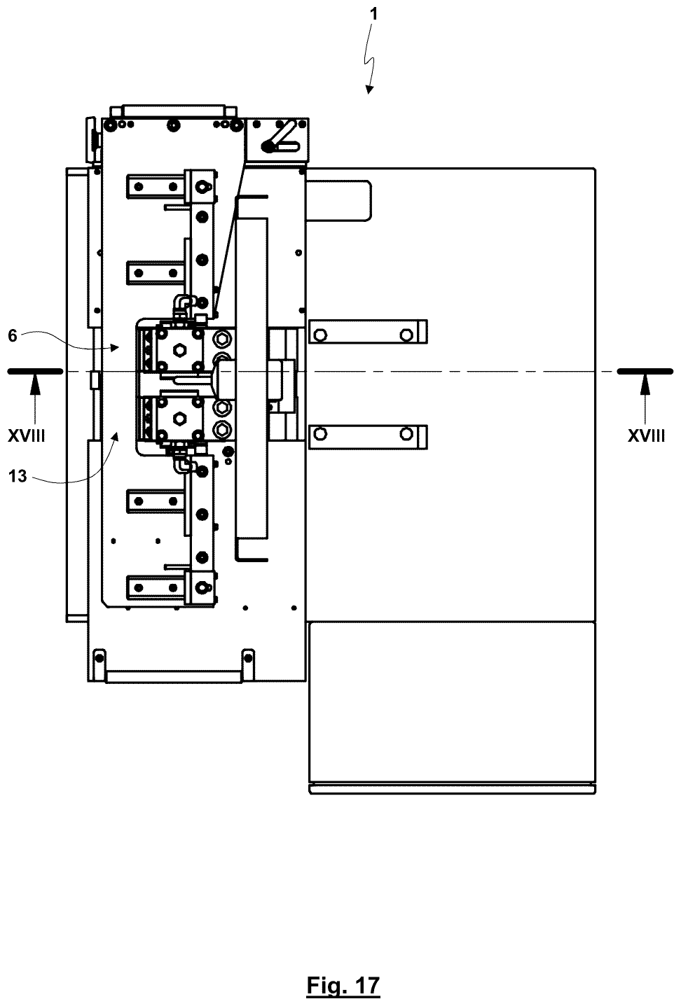

FIG. 17 in a top view shows the band flash butt welding machine electrode 6, 13 according to FIGS. 13 to 16 in a state installed in the band flash butt welding machine 1.

FIG. 18 shows a vertical section of the band flash butt welding machine 1 in the section XVIII-XVIII marked in FIG. 17.

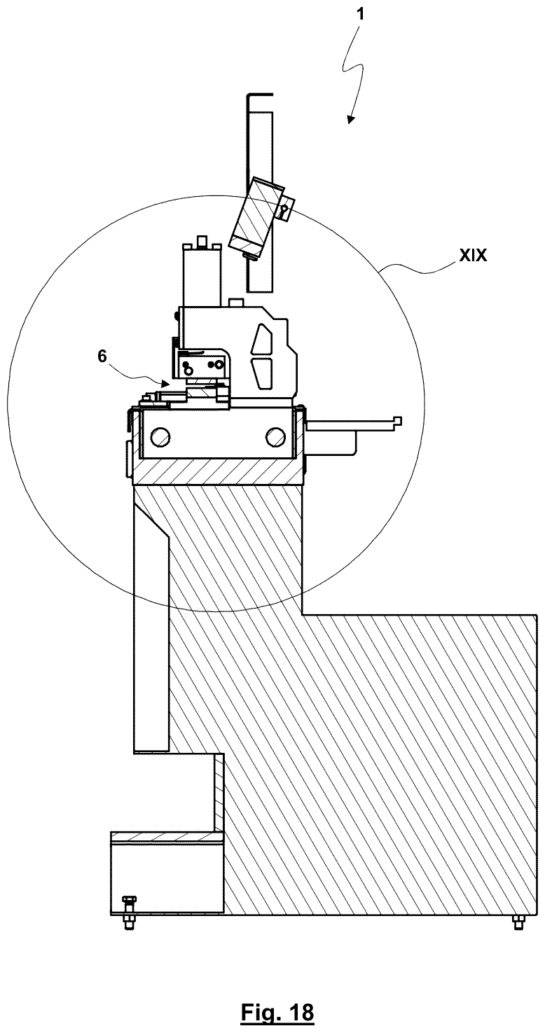

Detail XIX of this vertical section is shown in FIG. 19. It can be seen here that in one direction in the horizontal plane and transversely to the longitudinal axis 9, the band flash butt welding machine electrode 6 is supported with the end face of the alignment and/or positioning element 70 on a shoulder or a corresponding end face of the band flash butt welding machine 1. In this way, the position of the band flash butt welding machine electrode 6 in this direction and/or the alignment of the same are/is defined.

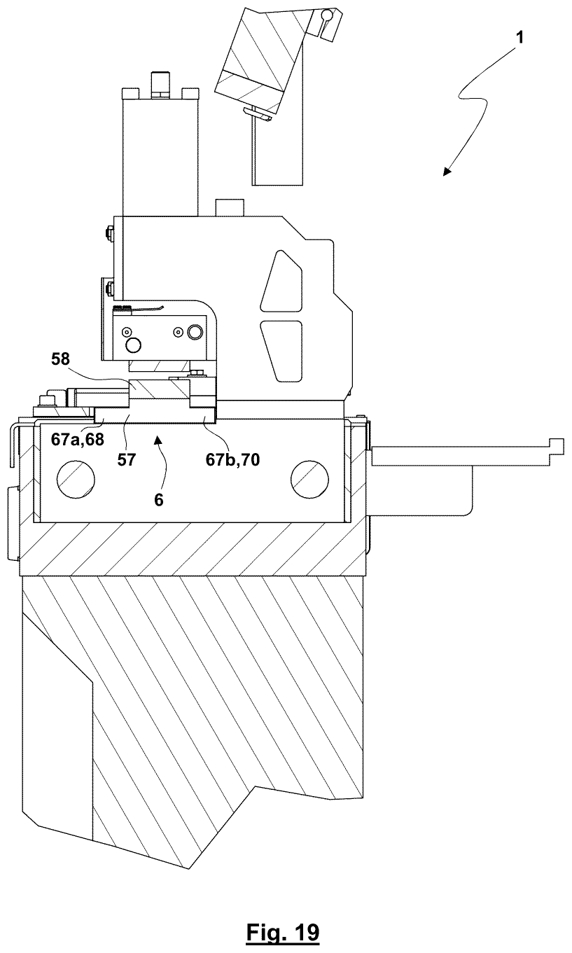

FIG. 20 schematically shows a band flash butt welding machine electrode 6, 13 with a base body 57 and a contact body 58. In FIG. 20, the left drawing part shows hatched the worn material of the band flash butt welding machine electrode 6, 13 during operation, which reduces the height of the contact surface 61 by ΔH (see reference number 71). If the band flash butt welding machine electrode 6 can no longer be operated in this state, it is replaced by a new contact body 58, as shown in the right drawing part of FIG. 20.

In FIGS. 20 to 22, the addition “−1” or “−2” indicates that it is a first (old) or a second (or new) component.

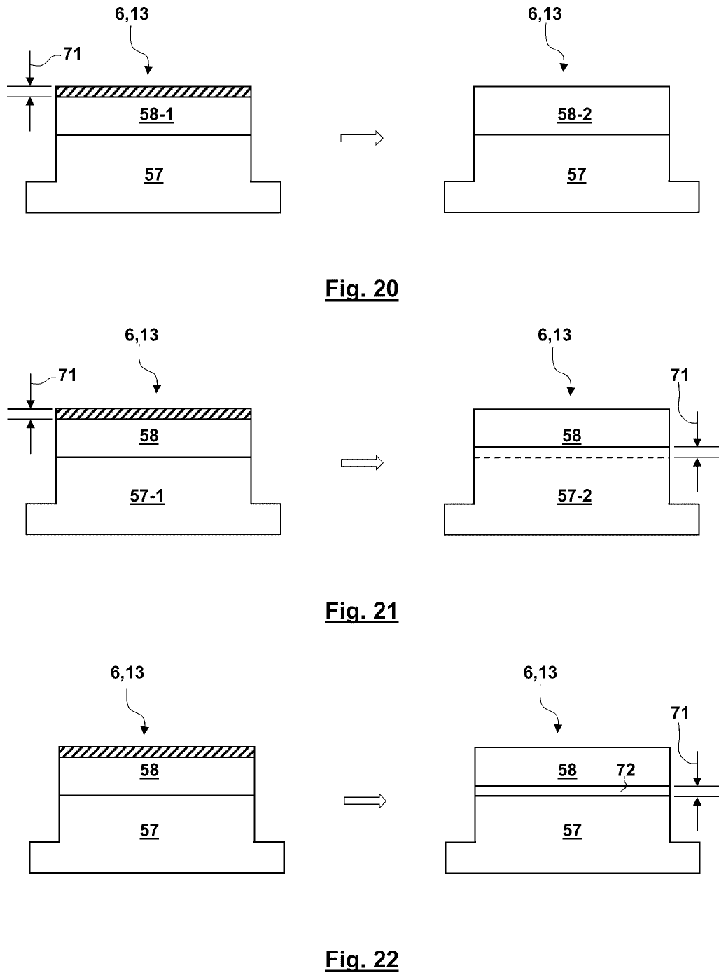

In FIG. 21, the band flash butt welding machine electrode 6, 13 is restored in a different way. Here, the same contact body 58 can still be used despite of the wear by height 71. In this case, the base body 57-1 is replaced by a new base body 57-2. The base bodies 57-1, 57-2 differ in their heights: For the base body 57-2, the height H of the base body 57-1 is shown as a dashed line. The height of the base body 57-2 is just higher than the height of the base body 57-1 by the height difference 71, so that the height of the base body 57-2 is H+ΔH.

In FIG. 22, the same base body 57 is used and the contact body 58 continues to be used despite of the wear. In this case, however, a compensating body 72 is used between the base body 57 and the worn contact body 58, which is embodied as a plate and whose height corresponds to the height difference 71.

When operating a band flash butt welding machine as described above, the band flash butt welding machine is first operated with a contact body until a predetermined amount of wear has occurred or a predetermined number of operating cycles has been reached, so that a reduction in the height of the contact body by ΔH has occurred. The band flash butt welding machine electrode is then removed and the contact body of the band flash butt welding machine electrode is replaced by a new contact body. The contact body can be connected to the base body using locating pins and/or fixing screws. Optionally, the contact surface of the new contact body can then be reworked, preferably to achieve plane parallelism between the contact surface of the new contact body for the band end and the lower side of the base body. Post-processing can also be carried out to ensure that the contact surfaces of the first band flash butt welding machine electrode and the second band flash butt welding machine electrode for the two band ends are arranged in one plane. The band flash butt welding machine electrode with the contained new contact body is then fitted to the band flash butt welding machine. The band flash butt welding machine can then be operated with further operating cycles, whereby the same base body with the new contact body can then be used in these further operating cycles.

Alternatively, the band flash butt welding machine can first be operated in accordance with the method described above until a predetermined wear or a predetermined number of operating cycles is reached and the band flash butt welding machine electrode is disassembled. In this case, however, the base body of the band flash butt welding machine electrode is then replaced by a new base body, the new base body comprising a height increased by ΔH, or a compensating body is fitted with the new base body. The difference between the heights of the base body and the new base body or the height of the compensating body correlates with the wear of the contact body by the height difference ΔH during operation of the band flash butt welding machine until a predetermined wear or a predetermined number of operating cycles is reached. Optionally, the contact surface of the contact body with the band end can then be reworked (as explained above). The band flash butt welding machine electrode with the new base body or the compensating body is then fitted to the band flash butt welding machine. The band flash butt welding machine can then be operated until a predetermined level of wear or a predetermined number of operating cycles has been reached, and so on.

The following may optionally, alternatively or cumulatively apply to the design of the band flash butt welding machine electrodes 6, 13:
a) The band flash butt welding machine electrode 6, 13 can be embodied as at least two parts and comprising a base body 57 and a contact body 58.
b) The base body 57 and the contact body 58 can be connected to each other via vertically oriented fixing screws 63 and/or locating pins 64.
c) The band flash butt welding machine electrode 6, 13 can be embodied as at least three parts and comprising the base body 57, the contact body 58 and at least one compensating body 72.
d) The compensating body 72 can be embodied as a plate with a plate height that is less than 10 mm.
e) The contact body 58 can be embodied as a plate with a height that is less than 60 mm.
f) The contact body 58 can project in the direction of the longitudinal axis 9 of the band over the base body 57 and/or over a compensating body 72 arranged between the base body 57 and the contact body 58.
g) The base body 57 can project transversely to the longitudinal axis 9 of the band over the base body 57 and/or over a compensating body 72 arranged between the base body 57 and the contact body 58.
h) An electrode set may comprise at least two base bodies 57-1, 57-2 and/or compensating bodies 72 having different heights.

In the present embodiments the opposing edges of the saw band, so the band back and the side of the saw band with the teeth, preferably have the same length.

Many variations and modifications may be made to the preferred embodiments of the invention without departing substantially from the spirit and principles of the invention. All such modifications and variations are intended to be included herein within the scope of the present invention, as defined by the following claims.

We claim:

1. A band flash butt welding machine for welding end faces of band ends of at least one band, the band flash butt welding machine comprising
a) first clamping elements for clamping a first band end and second clamping elements for clamping a second band end,
b) a first aligning element comprising a first aligning surface for aligning the first band end and a second aligning element comprising a second aligning surface for aligning the second band end, wherein:
the second clamping elements are movable in the direction of a longitudinal axis relative to the first clamping elements,
the first aligning element and the second aligning element are coupled to one another by a coupling device which defines a relative alignment of the first and second aligning elements, and
the second clamping elements can be moved translationally in the direction of the longitudinal axis relative to the first and second aligning elements via the drive.

2. A band flash butt welding machine according to claim 1, wherein the coupling device is an electronic coupling device.

3. A band flash butt welding machine according to claim 1, wherein the coupling device is a mechanical coupling device which fixedly connects the first alignment element and the second alignment element to one another during a changeover.

4. A band flash butt welding machine according to claim 3, wherein the coupling device comprises a bridge part comprising
a) a first bridge part section comprising the first aligning element
b) a second bridge part section comprising the second aligning element.

5. A band flash butt welding machine according to claim 4, wherein a recess is arranged between the first bridge part section and the second bridge part section and in the area of the recess at least one of
a weld seam is created and/or
a working area of a tool of the band flash butt welding machine is arranged and/or
the clamping elements and/or the band flash butt welding machine electrodes are arranged.

6. A band flash butt welding machine according to claim 3, wherein the coupling device with the aligning elements held thereon is guided by a transverse guiding device with a degree of freedom in a transverse direction.

7. A band flash butt welding machine according to claim 6, wherein an arresting device is provided by which the degree of freedom of the transverse guiding device can be arrested in the transverse direction.

8. A band flash butt welding machine according to claim 3, wherein the coupling device with the alignment elements held thereon is guided by a guide device relative to a slide which guides the second clamping element for movement in the direction of the longitudinal axis.

9. A band flash butt welding machine according to claim 3, wherein the coupling device with the alignment elements held thereon is movable in the transverse direction via a drive.

10. A band flash butt welding machine according to claim 9, wherein a transmission is arranged in the force flow between the coupling device with the aligning elements held thereon and the drive.

11. A band flash butt welding machine according to claim 10, wherein the transmission is a spindle drive.

12. A band flash butt welding machine according to claim 3, wherein the coupling device with the alignment elements held thereon can be moved manually in the transverse direction.

13. A band flash butt welding machine according to claim 12, wherein a transmission is arranged in the force flow between the coupling device with the aligning elements held thereon and a manual operating element.

14. A band flash butt welding machine according to claim 3, wherein the transmission is a spindle drive.

15. A band flash butt welding machine according to claim 1, wherein at least one of the first clamping elements and/or at least one of the second clamping elements is a band flash butt welding machine electrode.

16. A band flash butt welding machine according to claim 15, wherein at least one flash butt welding machine electrode comprises
a) a base body, by which the band flash butt welding machine electrode is fastened, and
b) a contact body, which is pressed against the associated band end for contacting.

17. A band flash butt welding machine according to claim 4, wherein at least one insulation element is present, which separates an electrical connection of the aligning elements via the bridge part.

18. A band flash butt welding machine according to claim 4, comprising a fixation area by means of which the bridge part can be attached to the band flash butt welding machine and a transverse guide device which couples the fixation area to the bridge part with a degree of freedom in a transverse direction.

19. A band flash butt welding machine according to claim 18, wherein
a) the bridge part with the first aligning element and the second aligning element,
b) the fixation area by means of which the accessory assembly group can be attached to the band flash butt welding machine and
c) the transverse guide device which couples the fixation area to the bridge part with a degree of freedom in a transverse direction are components of an accessory assembly group.

20. Accessory assembly group according to claim 19, wherein the accessory assembly group comprises an intermediate body which can be arranged between a foundation and at least one of
a) a tool of the band flash butt welding machine,
b) an actuator for one of the clamping elements,
c) the bridge part,
d) one of the aligning elements,
e) a band flash butt welding machine electrode, or
f) one of the clamping elements.
